(19) United States
(12) Patent Application Publication
(10) Pub. No.: US 2004/0098292 A1
(43) Pub. Date: May 20, 2004

(54) System and method for enabling supplier manufacturing integration

(76) Inventors: Lynn R. Miller, Puyallup, WA (US); Paul R. Frank, Auburn, WA (US); Gary S. Berg, Covington, WA (US); David J. Rainey, Kent, WA (US); Martin A. Zeigler, Seattle, WA (US)

Correspondence Address: HARNESS, DICKEY & PIERCE, P.L.C., P.O. BOX 828, BLOOMFIELD HILLS, MI, 48303, US

(21) Appl. No.: 10/298,774

(22) Filed: Nov. 18, 2002

(51) Int. Cl. G06F 17/60

(52) U.S. Cl. 705/8; 705/9

(57) ABSTRACT

A system and method for enabling supplier manufacturing integration to allow coordination of, and access to, information between various groups within a supplier and an organization procuring a component from the supplier. The system includes a network application that operates to integrate the supplier with personnel from the organization into a substantially concurrent, asynchronous, and collaborative design and build process. The system allows a user to select a business model for the supplier manufacturing integration process by choosing from a plurality of predefined process templates or by creating a customized process template. The system also allows for entry and updating of component data in accordance with the selected business model and the user's level of component data access and capability, which is determined by component status, the user's type, and the user's account type. The system further manages the component data and the various process steps in accordance with the selected business model.

### COPYRIGHT NOTICE

A portion of the disclosure of this document contains material that is subject to copyright protection. The copyright owner has no objection to the facsimile reproduction by anyone of the patent disclosure, as it appears in the U.S. Patent and Trademark Office patent files or records, but otherwise the copyright owner reserves all copyright rights whatsoever.

### FIELD OF THE INVENTION

The present invention relates generally to design and build processes and more particularly to an apparatus and method that integrates suppliers with personnel from an organization procuring a component from the supplier.

### BACKGROUND OF THE INVENTION

Many different business and technical processes and tools exist for communicating with suppliers during a design and build process. However, none of the existing processes and tools allow for management of communications and data exchange across the entirety of the various stages comprising the design and build process (e.g., concept, design, testing, procurement, process planning and production).

Functional and technical barriers exist that prevent internal and/or external suppliers from collaborating with the other parties (e.g., engineering, operations, numerical control (NC), manufacturing engineering (ME), tooling, quality assurance (QA), procurement, etc.) that are involved in the design and build process. For example, it is often the case that the component data (e.g., build package) is not readily accessible to the program engineer, buyer and the supplier's planner. Identification of proper contacts and then obtaining answers to resolve manufacturing questions can and often is difficult and time consuming. Coordinating tasks and timelines between the participants is problematical, i.e., who does what and when. Fabrication status at the supplier is frequently unknown by the buyer.

Because the product design ultimately determines how difficult it will be to manufacture the product, the product design has a major impact on the costs associated with manufacturing the product. Despite the known relationship between product design and manufacturing costs, many product designs, while suitable from a design perspective, are not easily manufactured and thus cannot be produced in an economical manner.

In addition, current supplier manufacturing processes also require design and build work to be performed sequentially. However, sequentially working on design and build can require significant amounts of time.

### SUMMARY OF THE INVENTION

Accordingly, a need remains for a system and method that enable supplier manufacturing integration (SMI) by integrating suppliers with engineering, operations, and procurement into a concurrent and collaborative process. Ideally, the system would allow the parties to work on a design and build package in a substantially parallel and asynchronous manner (i.e., not sequentially).

In one preferred form, the present invention provides a system for enabling supplier manufacturing integration and thus allow coordination of, and access to, information between various groups within a supplier and an organization or company procuring a component from the supplier. The supplier can be within the company or external to the company, i.e., an internal or external supplier. An important concept of the supplier manufacturing integration process is that it can be used in a similar manner with both internal and external suppliers. The system includes a network application that operates to integrate suppliers and manufacturers with personnel from an organization or company procuring a component from the suppliers and manufacturers into a substantially concurrent, asynchronous, and collaborative design and build process. The system allows a user to select a business model for the supplier manufacturing integration process by choosing from a plurality of predefined process templates or by creating a customized process template. The system also allows for entry and updating of component data in accordance with the selected business model and the user's level of data access and capability, which is determined by component status, the user's type and the user's account type. The system further manages the component data and the various process steps in accordance with the selected business model. Accordingly, the invention allows for substantial time and costs savings during the process of supplier manufacturing integration, as well as coordination of, and access to, important information between various groups within the supplier organization and the organization(s) designing and procuring the component.

Further areas of applicability of the present invention will become apparent from the detailed description provided hereinafter. It should be understood that the detailed description and specific examples, while indicating at least one preferred embodiment of the invention, are intended for purposes of illustration only and are not intended to limit the scope of the invention.

### BRIEF DESCRIPTION OF THE DRAWINGS

The present invention will be more fully understood from the detailed description and the accompanying drawings, wherein:

FIG. 1 is a schematic diagram of an exemplary system for enabling supplier manufacturing integration according to a first preferred embodiment of the present invention;

FIG. 2 is an illustration of an exemplary architecture taxonomy of the system shown in FIG. 1;

FIG. 3 is a functional block diagram of the network application shown in FIG. 1;

FIG. 4 illustrates exemplary process objects that may be used to create a business model for an integrated supplier manufacturing process enabled by the system shown in FIG. 1;

FIGS. 5A through 5D are process flow diagrams of exemplary process templates that may be used as a business model for an integrated supplier manufacturing process enabled by the system shown in FIG. 1;

FIG. 6 is an illustration of a Welcome window that may be displayed after a user has logged into the network application shown in FIG. 3;

FIGS. 7A and 7B are illustrations of a panel that may be displayed after the a user has activated a View Process Flow link;

FIG. 8 is an illustration of a panel displaying information about an Establish/Modify EIPT process step after the same has been selected by a user from the panel shown in FIG. 7B;

FIG. 9 is an illustration of a panel that may be displayed after a user has activated a Manage My Information link;

FIG. 10 is an illustration of a panel that may be displayed after a user has activated a Create New Component link;

FIG. 11 is an illustration of a panel that may be displayed after a Develop DPD Through Release process step has been selected by a user;

FIG. 12 is an illustration of a panel that may be displayed after a user activates an Attributes link from the panel shown in FIG. 11;

FIG. 13 is an illustration of a panel that may be displayed after a user activates an Images link from the panel shown in FIG. 11;

FIG. 14 is an illustration of a panel that may be displayed after a user activates a Digital Product Definition (DPD) Data link from the panel shown in FIG. 11;

FIG. 15 is an illustration of a panel that may be displayed after a user activates an Post a New Topic button from the panel shown in FIG. 11;

FIG. 16 illustrates an Event Notification panel;

FIG. 17 is an illustration of an exemplary message that may be posted by a user with the panel shown in FIG. 15;

FIG. 18 is an illustration of an Event Signoff panel;

FIG. 19 is an illustration of a Component Status panel;

FIG. 20 is an illustration of an exemplary warning notice that may be displayed when the component contains International Traffic In Arms (ITAR) controlled data;

FIG. 21 is an illustration of a Generate Reports panel;

FIG. 22 is an illustration of a panel that may be displayed after a Select Supplier and Release Contract process step has been selected by a user;

FIG. 23 is an illustration of an exemplary component's life cycle showing various stages that may be managed during an integrated supplier manufacturing process enabled by the system shown in FIG. 1;

FIG. 24 illustrates a panel that may be displayed after a Manage Component Lifecycle Link has been selected;

FIG. 25 illustrates an event notification window that may be displayed after a component life cycle state has changed to a Suspend Work life cycle state; and

FIG. 26 illustrates a panel that may be displayed after the event notification window in FIG. 25 has been completed.

Corresponding reference characters indicate corresponding features throughout the drawings.

### DETAILED DESCRIPTION OF THE PREFERRED EMBODIMENTS

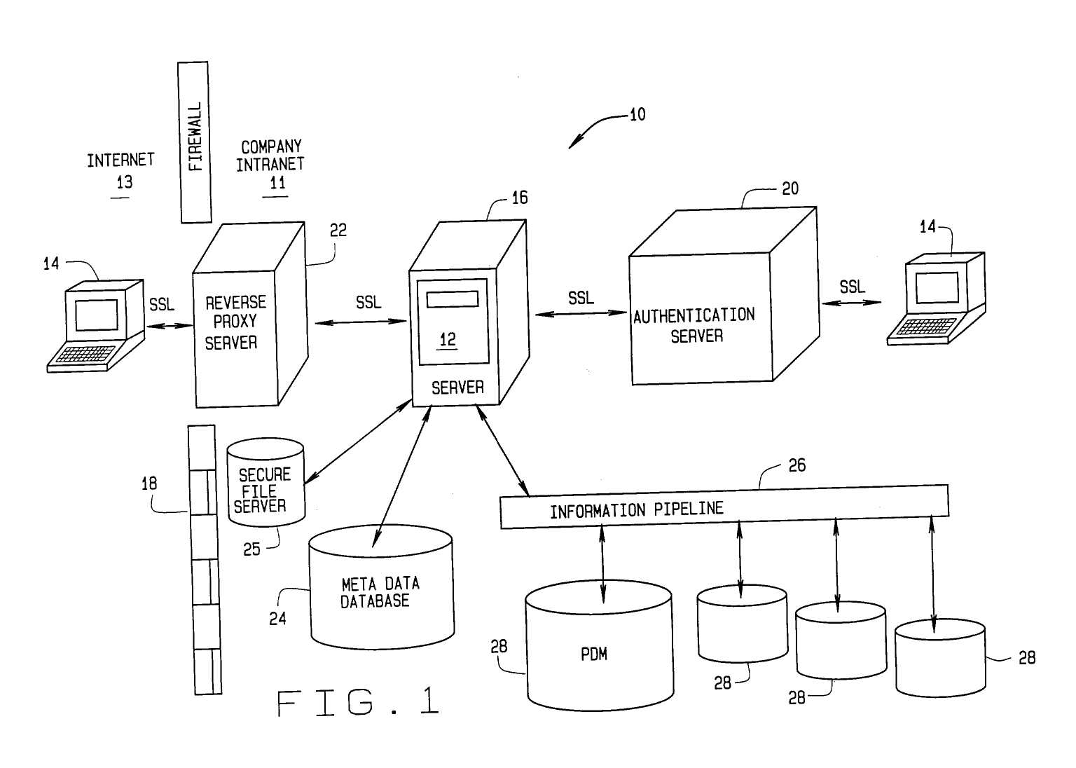

Referring to FIG. 1, there is shown an exemplary control system 10 according to one preferred embodiment of the present invention. Generally, the system 10 enables supplier manufacturing integration (SMI) by integrating suppliers and manufacturers with personnel from an organization or company procuring a component into a substantially concurrent, asynchronous, and collaborative process (e.g., define and produce, design and build, etc.). The company personnel, with whom the suppliers and manufacturer can collaborate, may include any number of suitable persons from various company departments or divisions including, but not limited to engineering, manufacturing, operations, numerical control (NC), tooling, quality assurance (QA), procurement, hardware managers, buyers, among others. In addition, the suppliers and manufacturers may be either internal or external to the company. It will be understood that the term “company” as used herein includes any organization, entity, or individual involved in procuring a component.

As described in greater detail below, the system 10 includes a network application 12 that allows for substantially asynchronous and concurrent collaboration (e.g., communication, data exchange, etc.) between the various parties via network devices 14 (e.g., laptop or desktop computer, etc.) throughout the various stages (e.g., concept, design, testing, process planning, production, delivery, etc.) of the supplier manufacturing integration process. Indeed, the invention allows suppliers and company personnel to begin communicating and recording component (e.g., part, tool, assembly, wiring, etc.), planning, and fabrication information as early as the conceptual stage regardless of the parties' physical location.

An exemplary supplier manufacturing integration process enabled by the system 10 may include the following steps. First, engineering uses the network application 12 to provide component data such as attributes, model files, images, and personal contact information. Next, the buyer uses the network application 12 to review the component data provided by engineering, to provide quotes or purchase data, and to grant one or more suppliers access to the component data. The supplier uses the network application 12 to review bid-to or build-to data, to provide quote responses and feedback including questions and/or producibility comments, and to report status during the fabrication of the component. It should be noted that the preceding integrated supplier manufacturing process is for descriptive purposes and that other processes may be used without departing from the spirit and scope of the invention.

As shown in FIG. 1, the system 10 comprises a Company Intranet 11 (i.e., an Intranet for the company procuring the component) linked to the Internet 13 or other wide area network (WAN). Other network embodiments, however, are possible for the system 10. For example, the system 10 need not be linked to the Internet 13 but may instead comprise just an Intranet or local area network (LAN). The system 10 may also comprise more, less, and/or other devices (e.g., input devices, output devices, peripheral devices (e.g., printers, scanners), storage devices, servers, routers, hubs, etc.) with such devices being linked to the system 10 via any suitable means (e.g., modem, T-1, digital subscriber line (DSL), infrared, other devices (e.g., routers, hubs), other networks (e.g., LAN, WAN, Intranet, the Internet, etc.), among other means). The particular configuration for the system 10 will likely depend at least in part on the parties involved in and the particular supplier manufacturing integration process for which the system 10 is being used.

With further reference to FIG. 1, the network devices 14 of the system 10 allow either internal or external parties to access the network application 12. Preferably, the network devices 14 comprise personal computers (PC).

The system 10 also includes a server 16 on which resides the network application 12, which is described in greater detail below. The server 16 comprises one or more computer readable storage media on which is stored the program code for implementing the network application 12. The server 16 may include any suitable computer readable storage device, such as read only memory (ROM), random access memory (RAM), video memory (VRAM), hard disk, floppy diskette, compact disc (CD), magnetic tape, a combination thereof, etc.

In addition to the network devices 14 and server 16, the system 10 further includes a firewall 18 between the Company Intranet 11 and the Internet 13, an authentication server 20 for internal user authentication, and a reverse proxy server 22 for external user authentication. Preferably, at least 128 bit encryption software and secure sockets layer (SSL) security protocol is used for data transactions across the system 10, although other data protection methods may be used.

The system 10 also includes a metadata database 24 and a secure file server 25, either of which may be used to store permanent data therein. An information depository or pipeline 26 is provided that links the system 10 to various product data management (PDM) systems 28, among other possible data and information services, software, and hardware.

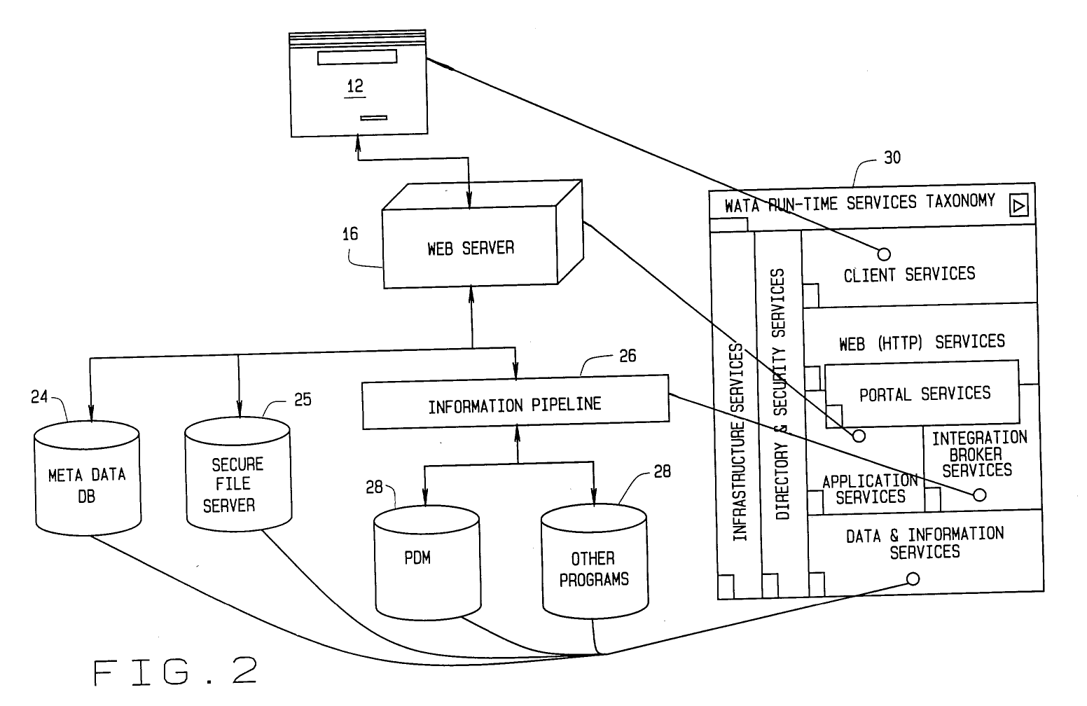

Referring now to FIG. 2, there is shown an illustration of an exemplary Web-enabled Application Integration Architecture (WAIA) Run-time Services Taxonomy 30 that may be used to implement the system 10. As shown in FIG. 2, the network application 12 comprises Client Services, the server 16 comprises Application Services, the information pipeline 26 comprise Integration Broker Services, and the metadata database 24, secure file server 25, PDM systems 28 comprise Data & Information Services.

The network application 12 of the present invention will now be discussed in greater detail. The network application 12 may be embodied in computer readable program code stored in one or more computer readable storage media operatively associated with the system 10. For example, the computer readable program code comprising the network application 12 may be hosted or stored in one or more computer readable storage media residing at, or associated with, the server 16. Alternatively, the computer readable program code comprising the network application 12 may be stored elsewhere, such as another network device or network site of the system 10.

It is to be understood that the computer readable program code described herein can be conventionally programmed using any of a wide range of suitable computer readable programming languages that are now known in the art or that may be developed in the future. It is also to be understood that the computer readable program code described herein can include one or more functions, routines, subfunctions, and subroutines, and need not be combined in a single package but may instead be embodied in separate components. In addition, the computer readable program code may be a stand-alone application, or may be a plug-in module for an existing application and/or operating system. Alternatively, the computer readable program code may be integrated into an application or operating system. In yet another embodiment, the computer readable program code may reside at one or more network devices (not shown), such as an administrator terminal, a server, etc.

In the preferred embodiment, the network application 12 comprises a dynamic web portal that enables remote web-based communication and data exchange between the various network devices 14 across the system 10. The network application 12 may be built using any of a wide range of standard HTML type web tools, such as Macromedia® ColdFusion® web development tool, which is commonly used for building and deploying web applications that interact with databases.

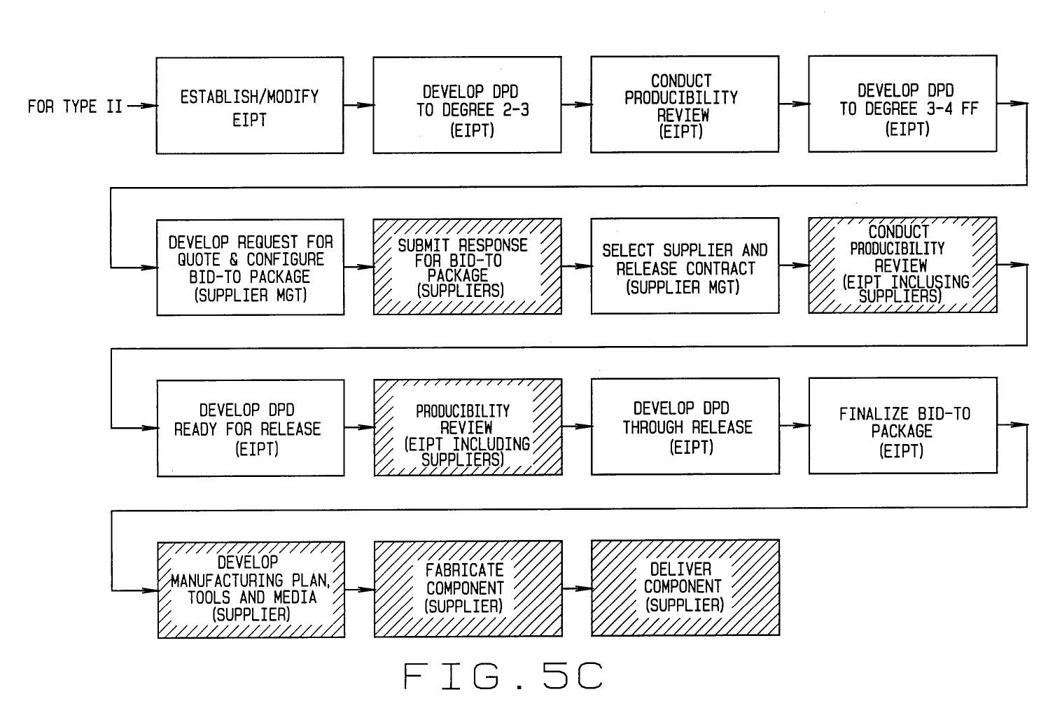

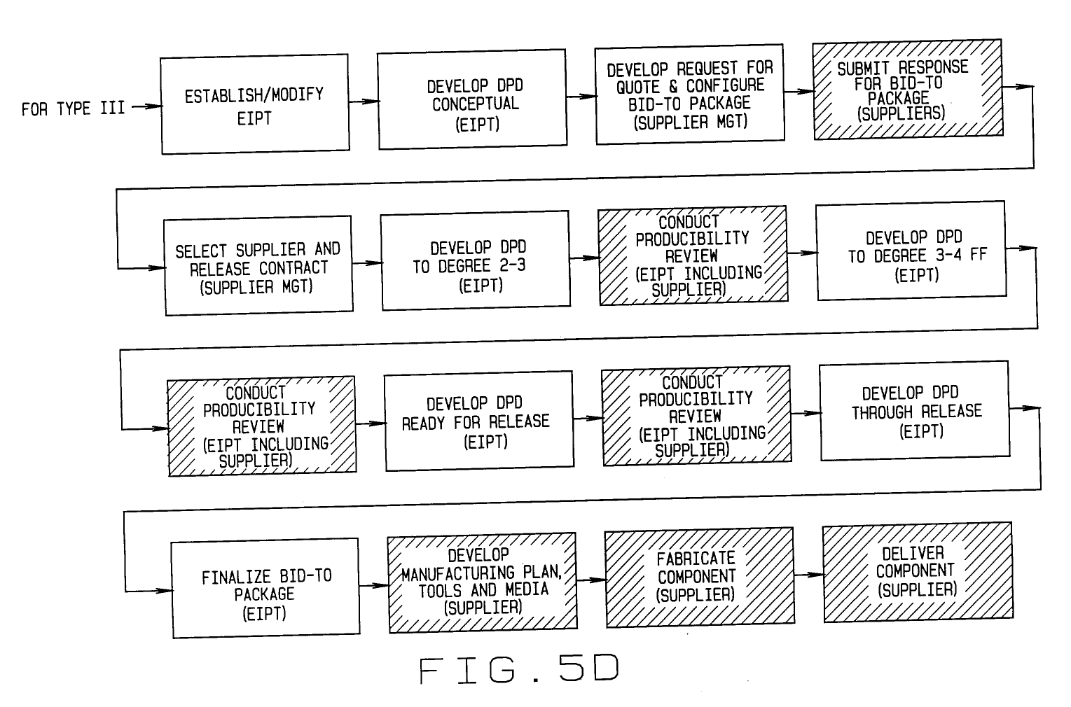

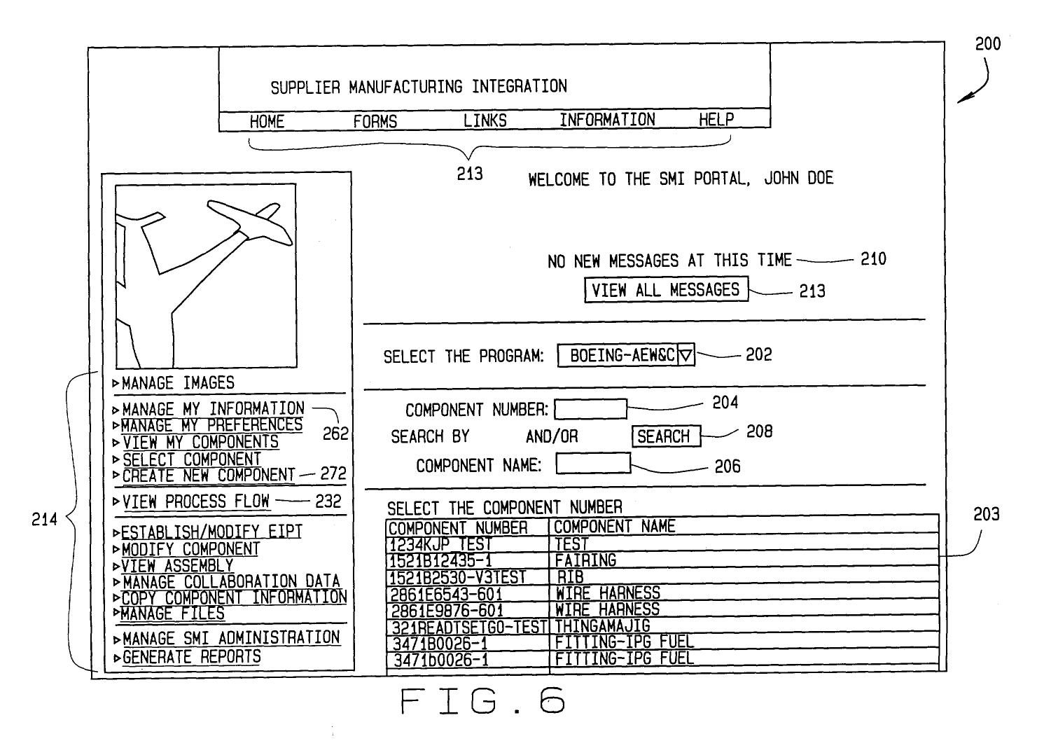

In the preferred embodiment, the execution of the network application 12 by the server 16 provides a user with a series of interactive screens or web pages (e.g., FIGS. 6 through 23) that are graphically displayed via an output component of a network device 14. The screen displays are preferably presented to the users in an easy to understand, easy to operate, and substantially identical fashion regardless of the type or location of the network device 14 being used to access the network application 12. Accordingly, the internal and external users can experience the look and feel of one system.

As described in greater detail below, the interactive screens allow the users to input the data, as needed, for the supplier manufacturing integration process. For example, the interactive screens may allow the user to update or enter personal contact information, to create a new component by entering a component number, name and type (e.g., machined, sheet metal, etc), to upload component 2D or 3D image(s), to create or comment on a discussion topic, to select a business model from predefined or customized process templates, to enter completion dates for various stages of the supplier manufacturing integration process, to sign off on events or process steps, among other things.

Although the present invention is described with the network application 12 having a direct effect on and direct control of the system 10, it should be understood that it is the instructions generated by the execution of the program 12 by the server 16, and the subsequent implementation of such instructions by the server 16, that have direct effect on and direct control of the system 10.

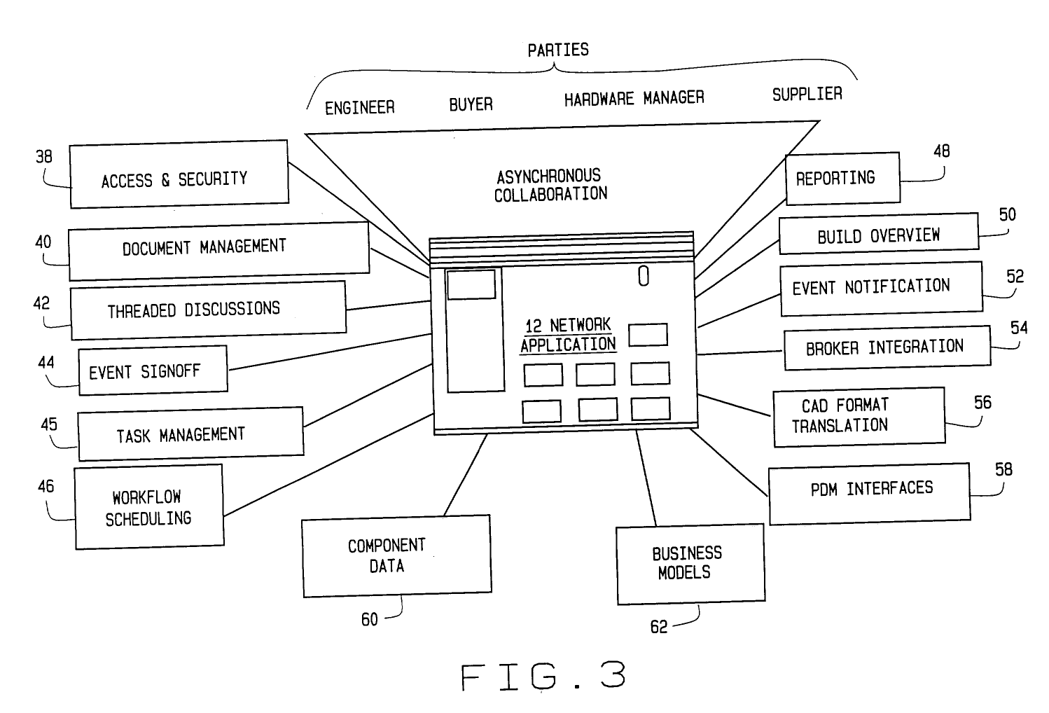

The functionality of the system 10 revolves around the use of the network application 12 to manage and enable the interchange of component information during the supplier manufacturing integration process. A number of the salient features and operations of the network application 12 are shown in FIG. 3 and will be described below. It should be noted, however, that the order that the operations are shown in FIG. 3 and described herein is for descriptive purposes only and should not be construed as limiting the scope of the present invention.

Generally, the various operations 38, 40, 42, 44, 45, 46, 48, 50, 52, 54, 56, and 58 shown in FIG. 3 allow the network application 12 to manage the various steps of the supplier manufacturing integration process, to manage the component data 60 provided by the parties (e.g., suppliers and company personnel), and provides event notifications 52 of the next process steps to the parties after the responsible person(s) has signed off 44 on a prior event or process step. The network application 12 performs each of these tasks per the business model used for the particular supplier manufacturing integration process. As described below, the business model may be selected from a plurality of predefined business models 62, or the business model may comprise a customized business model 64 created by a user.

The network application 12 provides a single resource for access to component definition data as well as bid-to data, build-to data, schedules, sketches, and inspection plans in support of the component. The network application 12 also provides a forum or chat room (e.g., threaded discussion operation 42) for discussions, action items, completion checklists, etc. between the parties (e.g., suppliers/manufactures and the company personnel such as product designers, engineers, buyers, hardware managers, etc.). The discussion items are managed as part of the component data. See FIGS. 17 through 19, which are described below.

During operation, the network application 12 collects or captures component data from the system 10 and makes the up-to-date and accurate component data accessible to the users (e.g., suppliers and company personnel). The network application 12 can present the component data relative to a corresponding step. The network application 12 also allows users to view the entire business process and/or their respective place in the process. The component data may include, but is not limited to, contact information, a component number, a component name, a component type, a component image, model based definition (MBD) data (e.g., geometries, part notations, design requirements, attributes, etc.), Computer Aided Design/Computer Aided Manufacturing/Computer Aided Verification (CAD/CAM/CAV) data (which may be formatted via operation 56), supplier management business information, bid-to package information, build-to package information, producibility review data, manufacturing and fabrication data, acceptance information, status information, purchase data, discussion items, and workflow schedules.

Regarding the Access & Security operation 38, the network application 12 employs a hierarchy to provide varied levels of data access and user capability based upon logins, contact lists, supplier access permissions, business models, user types and component statuses. The account type, user type, and component status determine the level of data access and capability and capability that a user will be granted by the network application 12.

For example, each user is assigned either a supplier account or a program IPT (integrated product team) account. Typically, the IPT comprises company personnel (e.g., engineers, buyers, hardware managers, etc.) but in certain cases may also include the supplier as well. The network application 12 allows IPT accountholders to view all program data and create new components. However, the network application 12 will not allow an IPT user to modify component data unless the IPT user is on the contact list for that specific component. Regarding supplier accounts, the network application 12 allows supplier accountholders to view data on a component-by-component basis, i.e., a supplier cannot view component data until granted access to that specific component.

In addition to varying the level of data access based upon account type, the authority to perform tasks, view and modify data also varies based upon user type. Preferably, the level of data access provided by the network application 12 is based upon the following four user types which are listed in order of descending authority: buyer, hardware manager, engineer, and supplier. In this example, buyers have the most authority and may, for example, grant suppliers access to component data. The buyer can view all communication to/from all suppliers. Conversely, suppliers have the least authority and may not, for example, modify component data. The suppliers can view only their own communication to/from the buyer and not buyer communication with other suppliers.

Further, the level of user access is also dependent upon the component status. In a preferred embodiment, the buyer or hardware manager assigns each component a status depending upon the specific business model that is being used and the maturity of the data. The component status then determines whether the data may be edited, locked from changes, or archived. As shown in FIG. 21, there are four component statuses that can be assigned by the buyer or hardware manager:

Prior to Bid (PreBid)— changes allowed;

Bid Package Available—locked from changes;

Prior to Build (PreBuild)— changes allowed (creates a history record of bid-to package);

Build Package Available—locked from changes.

Referring back to FIG. 3, the broker integration 54 and PDM interfaces 58 of the network application 12 allow the parties to access the data within the PDM systems 28 without having to learn the particularities associated therewith and without having an account for each PDM system 28. Instead, the user can use the network application 12 to access the data within any one of the PDM systems 28, and thus experience the look and feel of one uniform or standardized system.

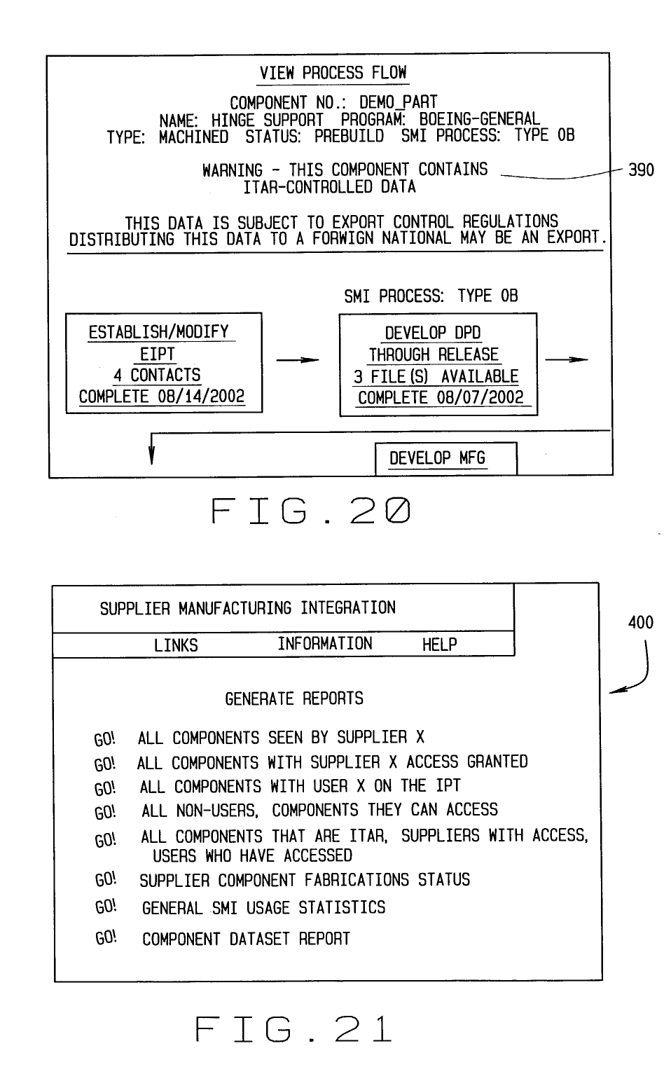

The network application 12 at operation 48 has the capability of generating a variety of reports. Exemplary reports include, but are not limited to: component status, all components seen by a particular supplier, all components for which a particular supplier has been granted access, all non-US users and the components they can access, among other reports as shown in FIG. 21. The network application 12 may also have the capability to generate a warning notice (FIG. 20) for identifying sensitive data, such as International Traffic In Arms (ITAR) controlled data, propriety data, among other data.

Referring again back to FIG. 3, the network application 12 at operation 50 allows for use of a build overview describing the manufacturing and acceptance strategies. The manufacturing strategy lists the methods and media to be used for manufacture of the component. The manufacturing strategy may include data such as material stock requirements, required tooling, required NC machines, number of NC media, general strategies such as automated versus hand operations and unique processing. The acceptance strategy lists the methods and media to be used for inspection. The acceptance strategy may include data such as machine simulation for NC program prove-out, in-process verification points and sketches for checking gages. The data for the build overview is typically input during the producibility reviews but can be input at any time during the supplier manufacturing integration process.

A build overview can be used for a variety of purposes such as: providing information to assist in supplier selection, providing purchase contract details relating to how the component will be manufactured and inspected, providing requirements for developing the manufacturing plan, media, and tools, allowing concurrent design and build media preparation, capturing the manufacturing or inspection media, allowing for re-use of media or tools from one supplier to another, among other uses.

As briefly mentioned earlier, the network application 12 also allows for the selection of a business model for the supplier manufacturing integration process. To accommodate for different programs, different teams, different groups, the network application 12 provides users with the flexibility to either select a business model 62 by choosing from a plurality of pre-defined process templates or by creating their own customized process steps and/or process templates. For example, a business model that includes early supplier involvement might be preferred in some instances but in other cases supplier involvement might not necessarily be needed until after the design is released. The network application 12 allows program unique decisions and process steps but maintains compatibility with an overall enterprise approach.

In the preferred embodiment, the network application 12 employs a unique approach using process objects and templates. As used herein, a “process object” is a specific event that represents a process step. A “process template” as used herein is a sequence of process steps, built using process objects, that define a business process and thus determines the type of interaction.

Once a process template is selected for a supplier manufacturing integration process, the process template guides the parties by laying out the data needed for each process step and indicating what steps need to happen and when. The process templates encompass the entire process and provide sufficient detail for logical organization of data. By accessing the network application 12, a user can view the various process steps mapped out by the process template and view the data associated with each process step.

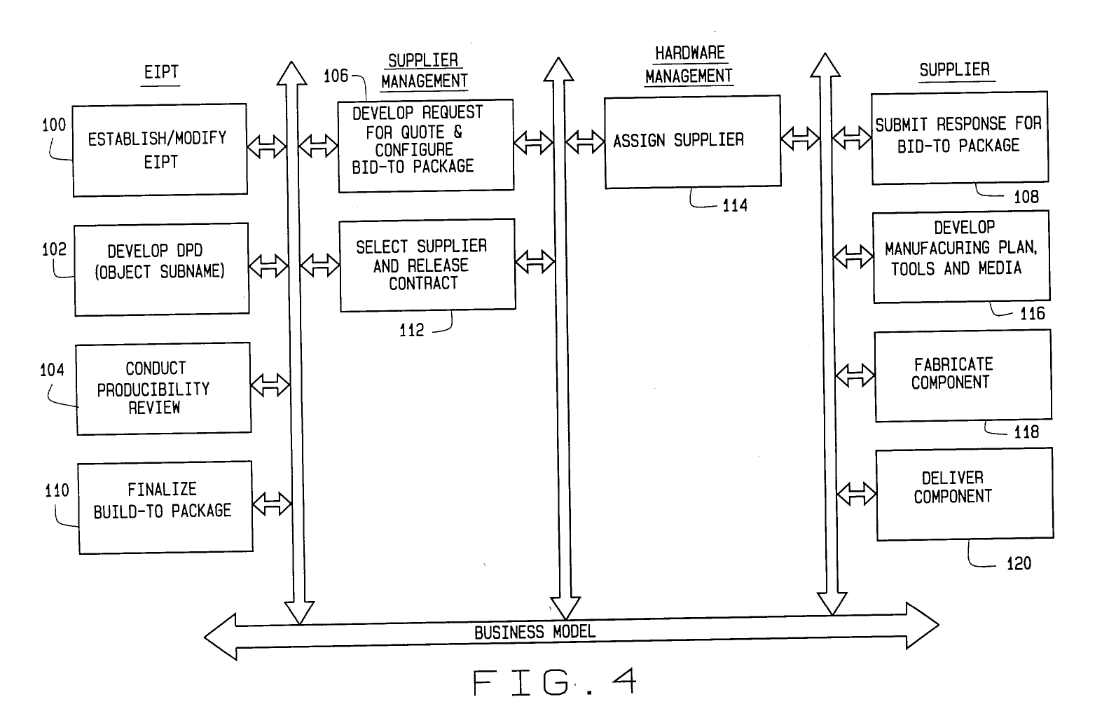

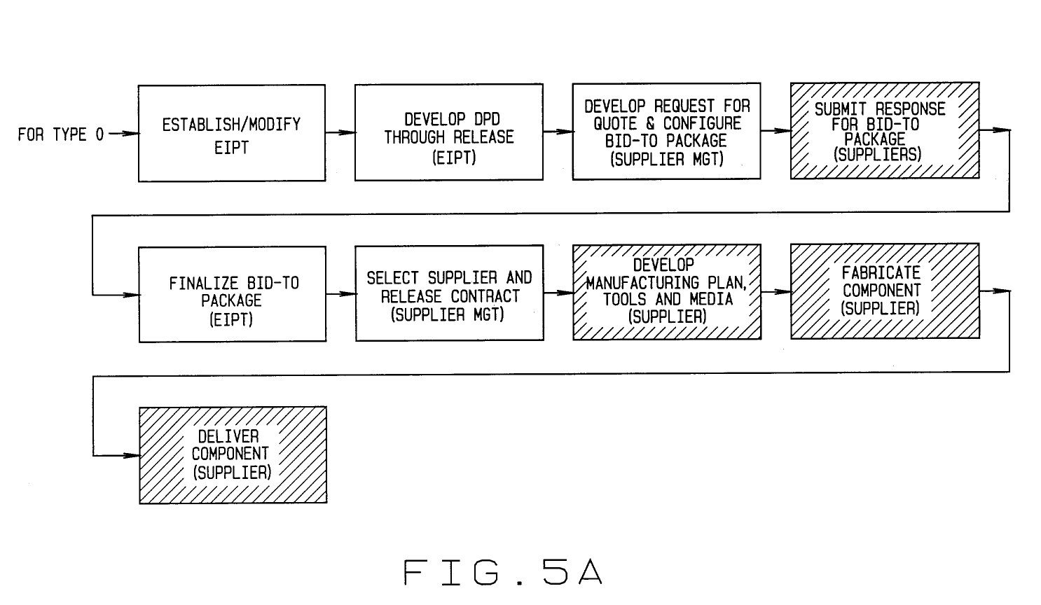

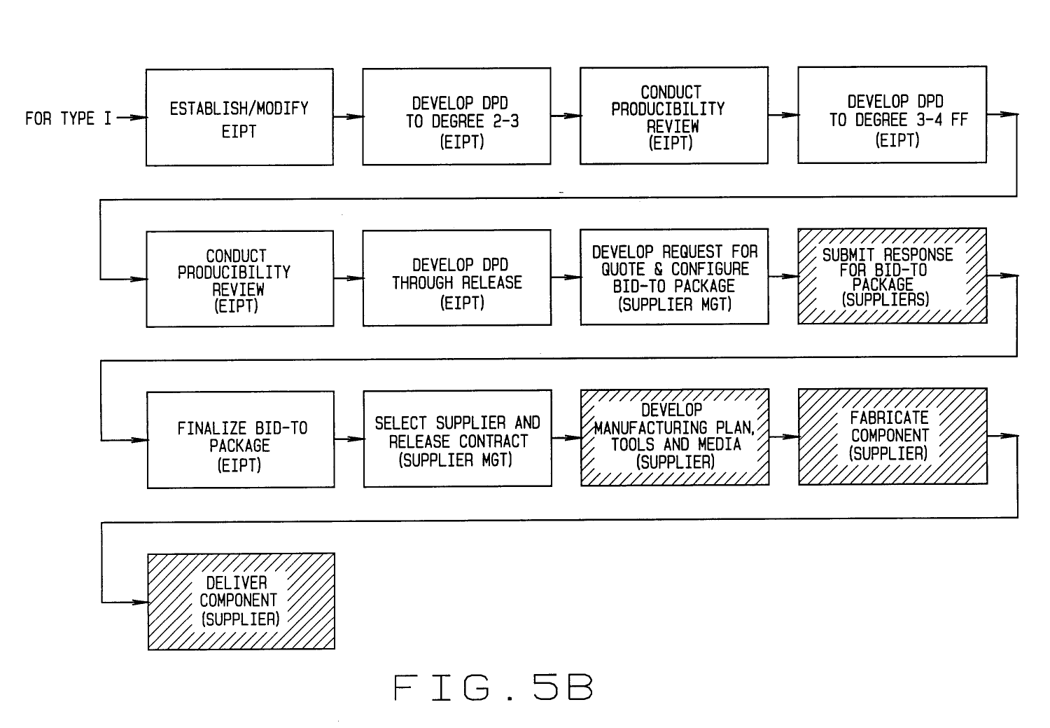

Various exemplary process objects or steps 100, 102, 104, 106, 108, 110, 112, 114, 116, 118, and 120 are shown in FIG. 4 and are described in greater detail later. Exemplary pre-defined templates are shown in the process flow diagrams FIGS. 5A, 5B, 5C, 5D wherein cross-hatched boxes represent supplier activity.

It should be noted that process objects are not limited to those shown in FIG. 4. Additional process objects may be defined in the system 10 to accommodate various events that define a wide variety of process steps and business models.

As used herein, the term “DPD” (Digital Product Definition) comprises the electronic data elements that specify the geometry and all design requirements for a component (including notation and parts lists) and support an integrated CAD/CAM/CAV system. In addition, the term “EIPT” (Extended Integration Product Team) comprises one or more persons from the program Integrated Product Team (IPT) which may include designers, engineers, tooling personnel, quality assurance personnel, and others supporting producibility reviews, procurement and fabrication such as CAD/CAM/CAV experts, supplier management and suppliers. Generally, the EIPT has the ultimate responsibility to assure the component meets design intent, is producible, manufactured and inspected in a cost effective manner, and is delivered per program schedule.

Referring to FIG. 5A, there is shown an exemplary template, referred to as Type 0, that supports a straightforward bid and procurement process for components of relatively simple complexity (i.e., components requiring little to no NC programming). The Type 0 template may be used when it is determined that supplier involvement in producibility reviews would not be beneficial. With the Type 0 template, the contract is awarded and the supplier becomes involved after engineering release.

FIG. 5B illustrates an exemplary template, referred to as Type I, that may be used for components of medium design or manufacturing complexity that are low to medium risk. The Type I template may be used when it is determined that producibility reviews with experts external to the program IPT would be beneficial. With the Type I template, the network application 12 is used to manage producibility reviews early in the process by the EIPT to ensure manufacturable, inspectable and cost-efficient designs.

FIG. 5C illustrates an exemplary template, referred to as TYPE II, that may be used for components of medium to high design or manufacturing complexity that are moderate or greater risk. The Type II template may be used when it is determined that producibility reviews with suppliers is desired. With the Type II template, the EIPT performs the initial review with company personnel. The suppliers bid on the component typically around feature freeze and provide producibility comments and suggestions. Supplier selection takes the supplier feedback into consideration. After being selected, the selected supplier participates as an EIPT member in a collaborative environment to review the product definition as the design is matured. The Type II template allows for reductions in the overall fabrication and delivery flow time due to early supplier involvement and contract award.

FIG. 5D illustrates an exemplary template, referred to as Type II, that may be used for high complexity and high risk components (i.e., components having high dollar costs and/or requiring special material form or process development). The Type III template provides a collaborative development environment between the program IPT and the supplier with early contract award based on conceptual product definition. The collaborative environment provided by the Type III template enhances the opportunity to begin development of the manufacturing plan and build media prior to engineering release.

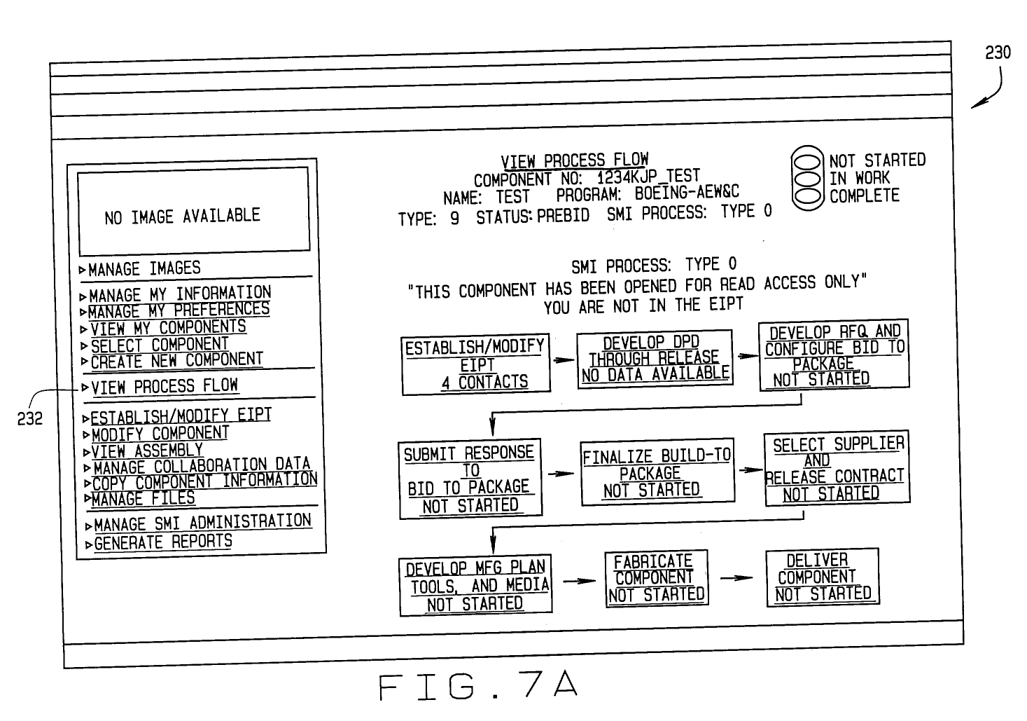

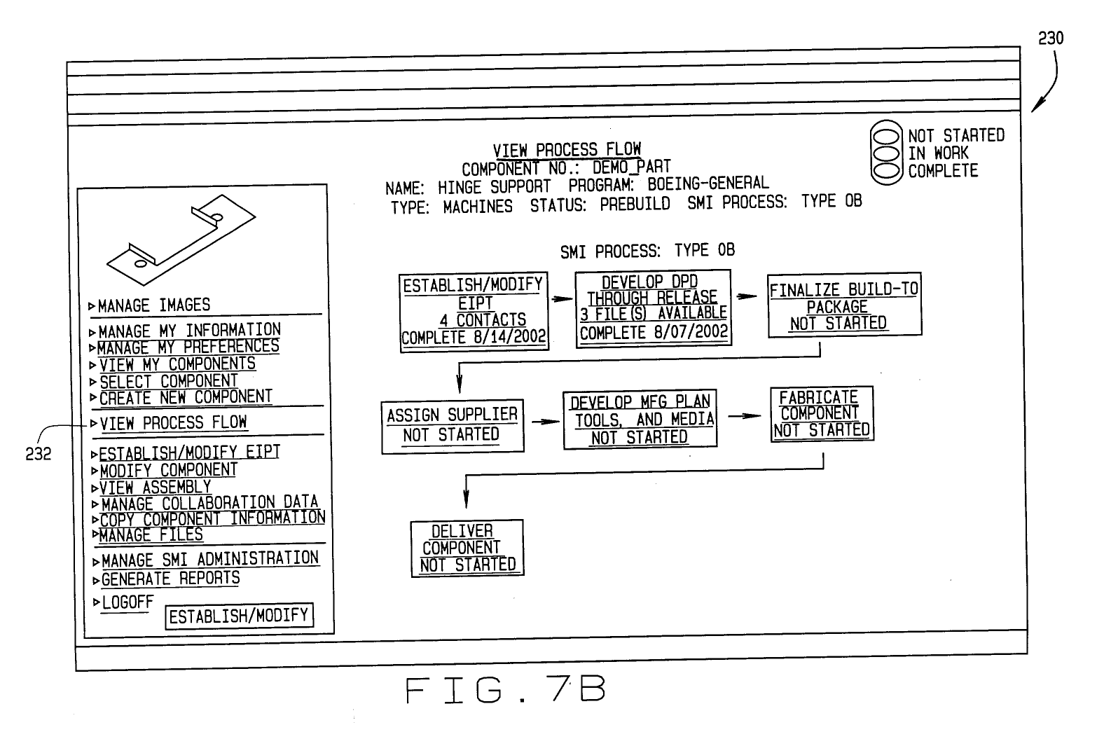

It should be noted, however, that other templates may be predefined and/or created by a user using the process objects 100 through 120 shown in FIG. 4 including, but not limited to, Program-Wide process templates (used to apply a customized process applied to a broad variety of components across the program), Work Package process templates (used to apply a customized process to large groups of logically associated components), and/or Component Family process templates (used to apply a customized process to small groups of similar components). A user may also create other templates by adding process steps to or omitting process steps from the Type 0, I, II, III templates shown in FIGS. 5A through 5D. As an example, templates, referred to herein as Type 0B (FIG. 7B), IB, IIB, and IIIB, may be created by replacing process objects 106 and 108 with process object 114 in Types 0, I, II, III templates, respectively, when a formal bid and contract award are not required. For example, a Type 0B, IB, IIB or IIIB template might be used for an internal supplier or an external supplier already on contract. The template ultimately selected for a supplier manufacturing integration process will likely depend on the particular application for which the system 10 is being used.

To initiate a supplier manufacturing integration process for a component, a user must first activate the component by using the network application 12. Generally, component activation comprises entering the component number, component category (machined, composite, wiring, etc.), related components, related work packages, contact information, ITAR identification, build overview option (on or off), and selection of a business model. A work-flow schedule and notes/comments may also be entered.

Once the component has been activated, the supplier manufacturing integration process proceeds to the various process objects comprising the user-selected business model (e.g., Type 0, I, II, III, etc.). The various tasks and actions that may be performed for each of the exemplary process objects shown in FIG. 4 will now be described in greater detail.

Referring now primarily to FIG. 4, the process object 100 comprises identifying the person(s) for the EIPT. The names of the team members may be entered into the network application 12 or copied from an EIPT existing in the network application 12. The EIPT is an extension of the initial contacts already identified for the component. Preferably, the EIPT allow each specialization to be represented early on the team. The initial membership of the EIPT will vary depending on the component and the process template being used. For example, an EIPT for a complex machined part with a Type I or II process template would typically include design engineering, stress engineering, manufacturing engineering, numerical control programming, a factory representative, numerical control quality assurance personnel, and supplier management. The supplier would likely be added to the EIPT after supplier selection. When a Type III process template is used, the supplier representatives would likely be included with the initial membership of the EIPT.

When the EIPT membership is completed or a new member is added, a notice may be sent via the network application 12 across the system 10 to each EIPT member. The following tables summarizes the input data and system output for the process object 100.

| Input Data | System Output |
|---|---|
| EIPT members | Application internal indication for need to |
| Notes/comments | ‘Establish EIPT’ |
| “Sign off” | Email sent and application internal message |
| indicating | logged to each EIPT member indicating that they |
| completion | are on the EIPT for subject component |
| | Application internal message logged to each EIPT |
| | member indicating event has been completed |

Process object 102 comprises placing the Digital Product Definition (DPD) in the program's PDM system 28 after the DPD reaches the desired level of maturity. The level of DPD maturity depends upon the specific process object sub-name. Sub-names used in Type 0, I, II, and III process templates and brief descriptions are as follows:

Develop DPD conceptual— the design is in the early conceptual stages;

Develop DPD to degree ⅔— the solid is matured to a degree ⅔ definition;

Develop DPD to degree ¾ FF—the solid is matured to a degree ¾ feature freeze definition (i.e., feature freeze refers to the point in time identified on the release schedule, prior to final engineering release, when the topology of the component will not change except for minor design modifications);

Develop DPD ready for release—the design is matured to a level that is ready for release; and

Develop DPD through release—the design has been released.

The following table summarizes the input data and system output for the process object 102.

| Input Data | System Output |
|---|---|
| Update or Add Component | Application internal indication |
| 2D or 3D image(s) | for need to ‘Develop DPD’ |
| Digital Product Definition | Application internal message |
| Parts List | logged to each EIPT member |
| Solid | indicating event has been |
| Drawing (native and/or | completed |
| neutral format) | |
| Notes/comments | |
| “Sign off” indicating | |
| completion | |

At the process object 104, the producibility review of the DPD is conducted by the EIPT to yield information relative to manufacturing, acceptance and design requirements. Although the producibility reviews can be held at various points during the supplier manufacturing integration process, the producibility reviews typically follow the process object 102. The level of maturity of the DPD determines the extent of the review. The following are three examples of producibility reviews.

The producibility review following Develop DPD to degree ⅔′ is an early look at a component for general characteristics (e.g., size, possible manufacturing machines, general complexity, datum's, tolerances, etc.), producibility implications, inspectability, manufacturability conditions, Critical Feature's (CF's), Key Characteristic's (KC's) and interfaces. Another aspect of the review is to discuss the standardization of features within the component family (e.g., all corner and fillet radii being consistent in similar pockets) and solid modeling techniques and approach. If a build overview is to be used, this is a preferred point to begin inputting the manufacturing and acceptance strategy.

The producibility review following ‘Develop DPD to degree ¾ FF’ is similar to the above producibility review but with a more mature feature freeze design. Review of the solid and other features assures accommodation of any previous EIPT reviews and provides an in-depth look at the design.

The producibility review following ‘Develop DPD ready for release’ is a final EIPT assessment of the mature DPD including tolerances and notes. A build overview, if used, can be matured at this time.

As each EIPT member completes his or her producibility review, the findings are logged in the network application 12 for engineering consideration to incorporate into the design. Engineering then documents their intent to address the findings from the EIPT's producibility review. When reviews are complete and addressed by design engineering, each EIPT member “signs off” their review. In summary, the process object 104 comprises a discussion to address the manufacturability issues and to understand all the current challenges, problems and opportunities.

The following table summarizes the input data and system output for the process object 104.

| Input Data | System Output |
|---|---|
| EIPT member review findings | Application internal indication |
| Review sketches or DPD mark | for need to ‘Conduct Producibility |
| ups (if required) | Review’ |
| Engineering response to review | Component data as requested |
| findings | by user (images, solid, parts list, |
| EIPT “sign off” (each member) | sketches, etc.) |
| Build overview manufacturing | Application internal message logged to |
| and acceptance strategy | each EIPT member indicating event has |
| (if required) | been completed |
| Notes/comments | |
| “Sign off” indicating | |
| completion | |

At process object 106, the bid-to package is configured within the network application 12 and made accessible thereby to the appropriate suppliers. The bid-to package includes supplier management business information and component information. The process template (Type 0, I, II, III, etc.) determines the kind of component DPD information and it's maturity level.

Type 0

Released DPD (solid, drawing, parts list, etc.)

Type I

Released DPD (solid, drawing, parts list, etc.)

Miscellaneous information (part attributes, producibility comments, etc.)

Build overview (if used)

Type II

Feature-freeze DPD (solid, parts list, etc.)

Miscellaneous information (part attributes, producibility comments, etc.)

Build overview (if used)

Type III

Conceptual DPD (solid, sketches, etc.)

Miscellaneous information (part attributes, producibility comments, etc.)

The following table summarizes the input data and system output for the process object 106.

| Input Data | System Output |
|---|---|
| RFQ and related information | Application internal indication |
| (due date, status, contract | for need to ‘Develop RFQ and |
| number, etc) | Configure Bid-to package’ |
| DPD data | Application internal message |
| Build overview (if required) | logged to each EIPT member |
| Notes/comments | and suppliers indicating event |
| Set permissions for supplier | has been completed |
| access to component | |
| “Sign off” indicating | |
| completion | |

At process object 108, the suppliers access the bid-to package through the network application 12 to review the data and respond with a bid proposal or as appropriate. Questions or comments may also be submitted through the network application 12. The suppliers may also provide producibility feedback on the DPD and the build overview (if used). When responses are complete (or response date reached), supplier access is removed.

The following table summarizes the input data and system output for the process object 108.

| Input Data | System Output |
|---|---|
| Supplier comments/questions | Application internal indication for |
| Supplier sketches or DPD | need to ‘Submit Response for Bid-to |
| markups | Package’ |
| Supplier response to RFQ | Component data as requested |
| Suppliers access to the | by user (images, solid, parts list, etc) |
| component removed | Application internal message logged |
| “Sign off” indicating | to supplier management EIPT member |
| completion | indicating each supplier response received |
| | Application internal message logged |
| | to each EIPT member indicating event has |
| | been completed |

At process object 110, the final build-to package containing the released DPD and the build overview (if used) is configured in the network application 12. The status is changed by the buyer or hardware manager to build. See FIG. 21. The component's final design and fabrication information is now available to be used for creation/completion of all media, tools and the suppliers manufacturing plan.

Depending upon the process template (Type 0, I, II, III, etc.) or supplier feedback on the design, the DPD and build overview may deviate from what was initially planned or bid on. If any changes affecting the cost of producing the component are identified, the purchase contact is reviewed and updated if necessary. The overall component workflow schedule should be reviewed and if necessary updated at this time.

The following table summarizes the input data and system output for the process object 110.

| Input Data | System Output |
|---|---|
| DPD data | Application internal indication for need to |
| Build overview (if required) | ‘Finalize Build-to Package’ |
| Schedule (update) | Application internal message logged to each |
| Notes/comments | EIPT member indicating event has been |
| “Sign off” indicating | completed |
| completion | |

At process object 112, the supplier's bid responses are reviewed for business aspects and supplier capabilities required for component manufacture. Contract negotiations are performed, as required leading to supplier selection and formation of a purchase contract. Supplier selection is preferably based on cost, schedule, manufacturing capabilities, and other program or contractual items identified by supplier management. If necessary, the EIPT participates to assure that components match process capabilities, preferred product lines, and best practices. Evaluation of supplier producibility comments or suggestions may also be needed. Engineering changes due to supplier feedback may result in the necessity to re-quote. Supplier selection decisions and pertinent information is input into the network application 12. Media and fabrication status checklists, which specify supplier reporting requirements (completion dates, etc), are completed. The selected supplier is given access to the component.

The following table summarizes the input data and system output for process object 112.

| Input Data | System Output |
|---|---|
| Selected supplier identification | Application internal indication for |
| Purchase contract | need to ‘Select Supplier and Release |
| Media and fabrication checklist | Purchase Contract’ |
| requirements | Suppliers RFQ response data |
| Notes/comments | Application internal message logged to |
| “Sign off” indicating | each EIPT member indicating event has |
| completion | been completed |

Process object 114 is used in lieu of process objects 106 and 112 when a formal bid and contract award process is not required. This is typically used with suppliers internal to the company or with external suppliers that are already on contract. The supplier is given access capability to the subject component. A contract or work authorization may be placed into the network application 12. Media and fabrication status checklists, which specify supplier reporting requirements (completion dates, etc), are completed.

The following table summarizes the input data and system output for process object 114.

| Input Data | System Output |
|---|---|
| Selected supplier identification | Application internal indication for |
| Contract/work authorization | need to ‘Assign Supplier’ |
| (if required) | Application internal message logged |
| Media and fabrication checklist | to each EIPT member indicating |
| requirements | event has been completed |
| Notes/comments | |
| “Sign off” indicating | |
| completion | |

At process object 116, the manufacturing plan, tools and media are created per the build-to package. Supplier questions on the design intent may be logged into the network application 12. The media status checklist, which indicates suppliers reporting requirements (completion dates, etc), is completed. Also, the supplier identifies any media development schedule deviations. If necessary, schedule changes are made after coordination with the EIPT.

The following table summarizes the input data and system output for process object 116.

| Input Data | System Output |
|---|---|
| Media (if required per | Application internal indication for |
| build overview) | need to ‘Develop mfg. plan, tools |
| Supplier questions or comments | and media’ |
| Schedule (update) | Application internal message logged to |
| Media status signoffs | each EIPT member indicating event has |
| “Sign off” indicating | been completed |
| completion | |

At operation 118, the supplier manufactures the component in accordance with the build-to package design, fabrication and contractual requirements. During fabrication, if any changes to the build-to package are identified, the update information is logged into the network application 12 for EIPT concurrence. First Article Inspection (FAI) and conformity inspection (if required) may also be tracked using the network application 12. The fabrication status checklist, which indicates suppliers reporting requirements (completion dates, etc), is completed. The supplier identifies any fabrication schedule deviations. If necessary, schedule changes are made after coordination with the EIPT.

The following table summarizes the input data and system output for process object 118.

| Input Data | System Output |
|---|---|
| Supplier questions or comments | Application internal indication for |
| Schedule (update) | need to ‘Fabricate Component’ |
| Fabrication status signoffs | Application internal message logged |
| “Sign off” indicating | to each EIPT member indicating event |
| completion | has been completed |

At process object 120, the supplier ships the component and records the delivery information into the network application 12. The following table summarizes the input data and system output for process object 120.

| Input Data | System Output |
|---|---|
| Delivery date, quantity, shipping | Application internal indication for need |
| company, etc. | to ‘Deliver Component’ |
| “Sign off” indicating completion | Application internal message logged to |
| | each EIPT member indicating event has |
| | been completed |

As briefly described earlier, the network application 12 preferably comprises a plurality of interactive screens may be displayed on an output display of a network device 14 during the execution of the network application 12 by the system 10. The user may interact (e.g., enter or change data within a panel) with the screens by using an input device of the corresponding network device 14. It should be noted, however, that a user need not necessarily enter the input parameters or access the interactive screens in the order that the exemplary screens are shown in FIGS. 6 through 23. Moreover, it should be noted that the plurality of interactive screens are shown and described herein for descriptive purposes only and should not be construed as limiting the scope of the present invention. For example, the screen displays may appear differently depending on user type (e.g., buyer, supplier, hardware manager, supplier, etc.).

FIG. 6 is an illustration of a Welcome window 200 that may be displayed after a user has logged into the network application 12. As shown, the Welcome window 200 comprises a program pull-down menu 202 and a component list 203, which may be searched via text entry boxes 204, 206 and Search button 208. The Welcome window 200 also includes an indicator 210 as to whether the user has any messages and a View All Messages button 212 for viewing the messages, if any. Additionally, a plurality of general information links 213 are also provided in top portion of the Welcome window 200.

The Welcome window 200 further includes a plurality of links 214. Each of the links 214 when activated allows the user to perform a corresponding task, some of which will now be described.

FIGS. 7A and 7B illustrate a panel 230 that may be displayed after a user has activated a View Process Flow link 232. The panel 230 provides the status for the various process objects comprising the business model template selected for the supplier manufacturing integration process. The panel 230 also displays various component information such as component number, name, program, type, status, and process template being used (e.g., Type 0 in FIG. 7A, Type 0B in FIG. 7B).

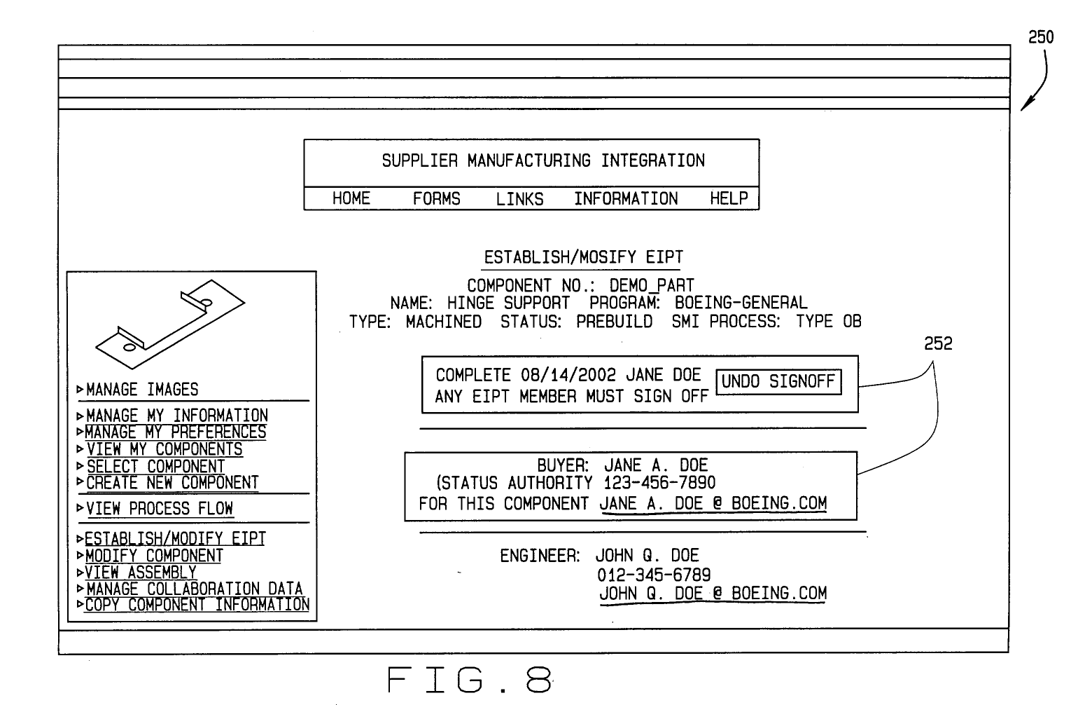

The network application 12 allows the user to view more detailed information about a process object by selecting or clicking on the process object displayed within the panel 230. For example, FIG. 8 illustrates a panel 250 in which is displayed information 252 about the Establish/Modify EIPT process object 254 after the same has been activated by the user from the panel 230 shown in FIG. 7B.

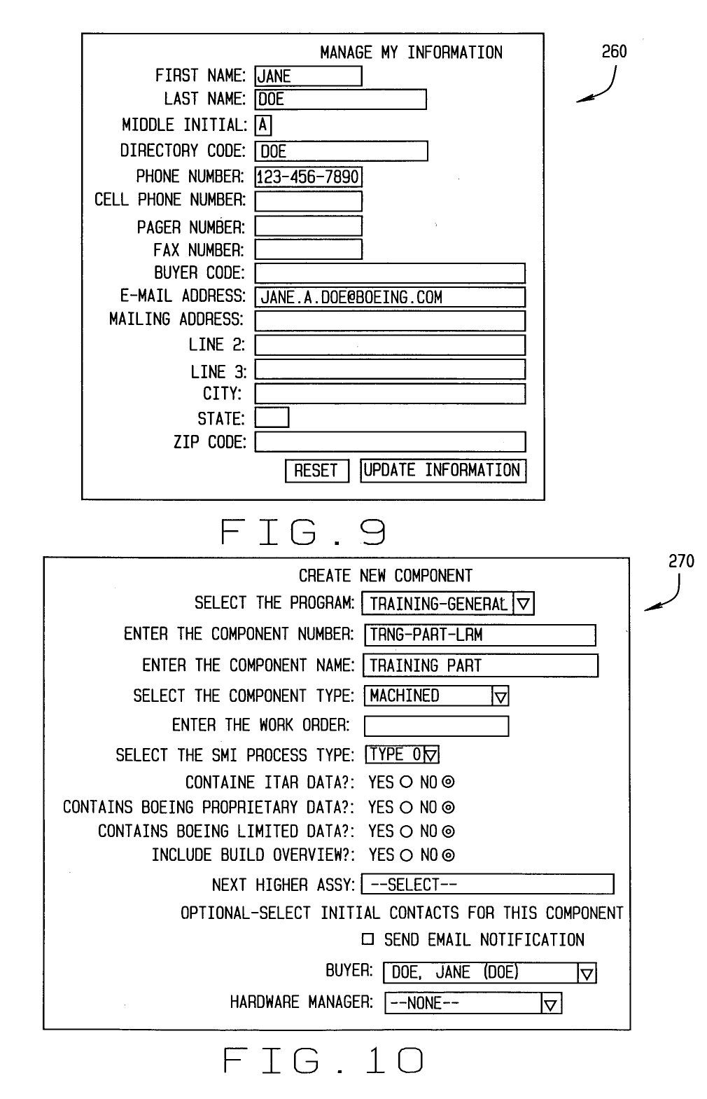

FIG. 9 illustrates a panel 260 that may be displayed when the Manage My Information link 262 is selected from the plurality of links 214 (FIG. 6). Generally, the panel 260 allows the user to create, review, and update personal information such as phone numbers and addresses.

FIG. 10 illustrates a panel 270 that may be displayed when the Create New Component link 272 is selected from the plurality of links 214 (FIG. 6). Generally, the panel 270 allows the user to create a new component, establish the user as the proper contact for that component, and enter various other data for the new component, assuming the user has the requisite authority as previously described.

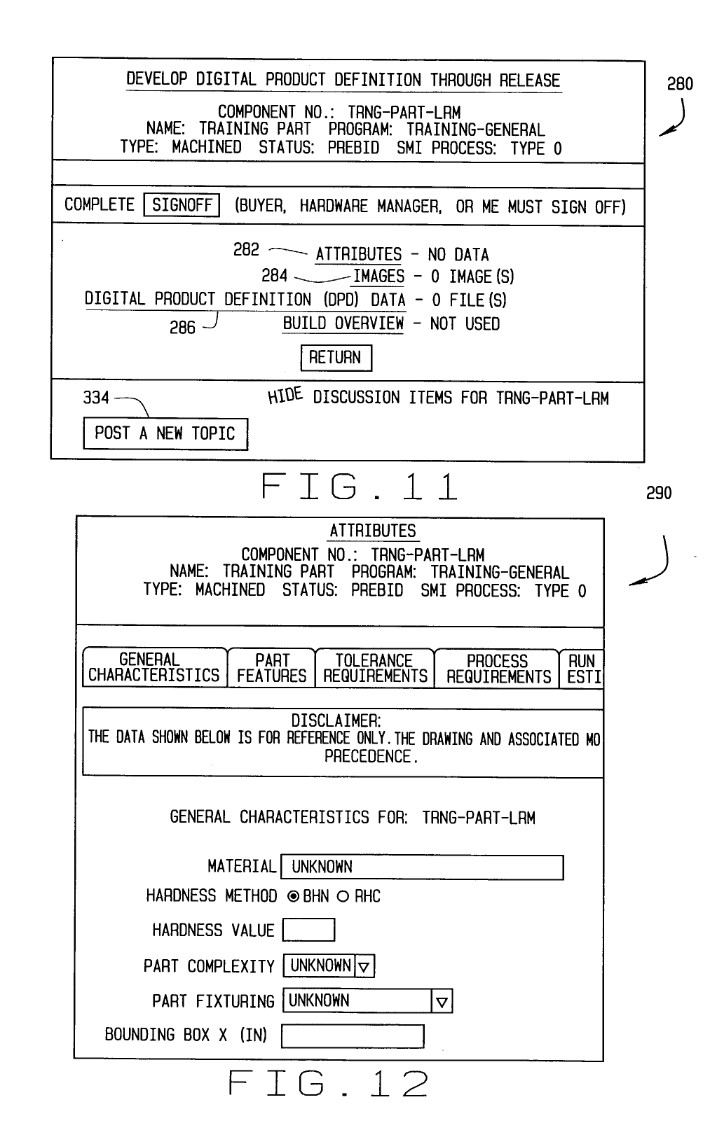

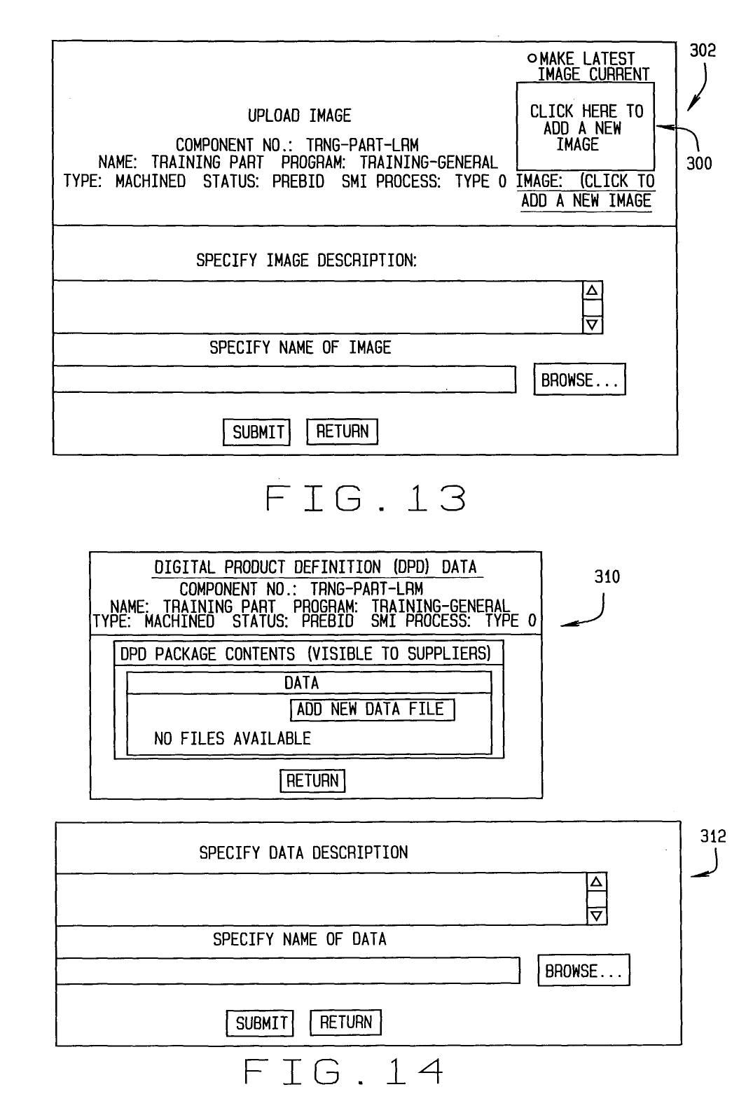

FIG. 11 illustrates a panel 280 after the process step Develop DPD Through Release has been selected by the user. Generally, the panel 280 allows the qualified user to enter DPD attribute data for the component via panel 290 (FIG. 12) which are displayed after the user clicks on the Attributes link 282 (FIG. 11), to upload an image of the component via panels 300 and 302 (FIG. 13) which are displayed after the user clicks on the Images link 284 (FIG. 11), and/or to upload a CAD model via panels 310 and 312 (FIG. 14) which are displayed after the user clicks on the Digital Product Definition (DPD) Data link 286 (FIG. 11).

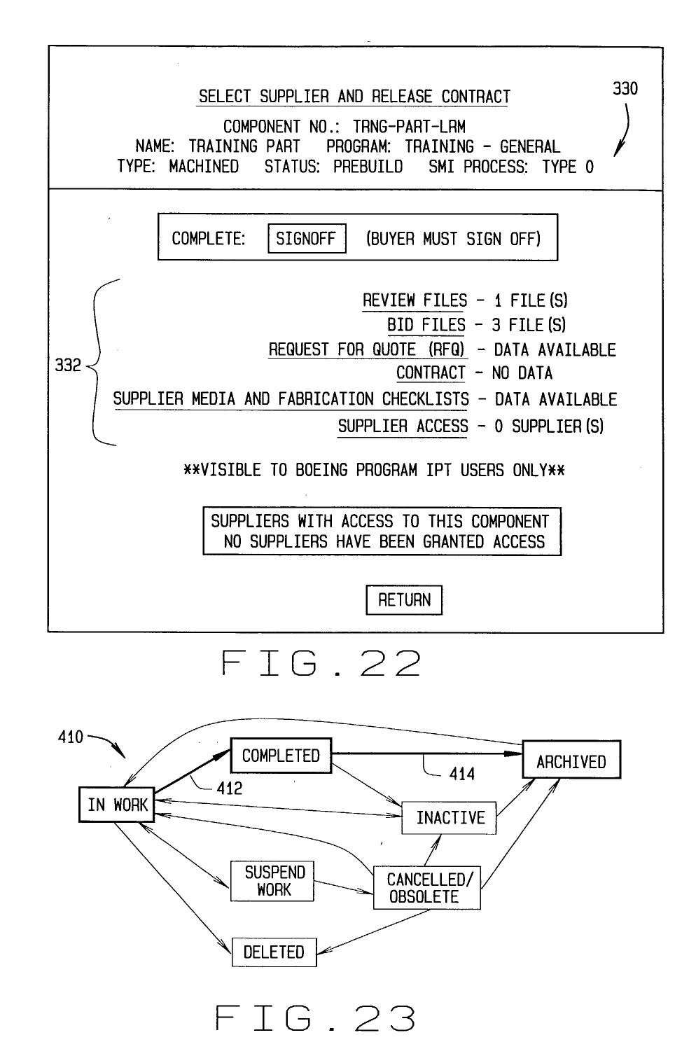

FIG. 22 is an illustration of a panel 330 that may be displayed after a Select Supplier and Release Contract process step has been selected by a user. As shown, panel 330 includes a plurality of links 332 that allow the user to access various information associated with the links 332.

FIGS. 11 and 22 illustrate the task and data organization within the system 10 wherein the process object tasks to be performed and the required data are organized in a logical sequential manner. Only the information needed to perform the current process step is presented. The tasks and data within all process objects are organized in this manner to aid the user in performing his or her task.

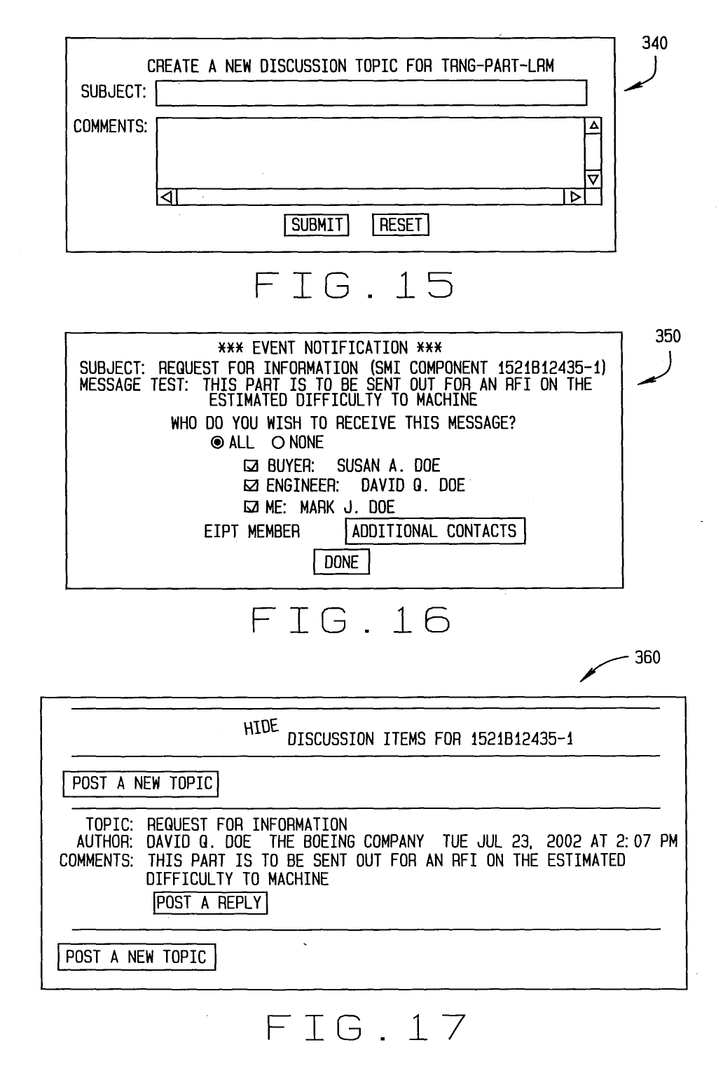

With further reference to FIG. 11, the panel 280 also includes a button 334 that allows the user to add a discussion item about the component. Upon activation of the button 334, the panel 340 (FIG. 15) is displayed that allows the user to create a new discussion topic for the component. The user may then choose which user(s) will receive the message via panel 350 (FIG. 16). FIG. 17 is an illustration of an exemplary message 360 that may be posted by a user. The capability to enter discussion items is provided throughout the various panels to provide quick and easy access for the user.

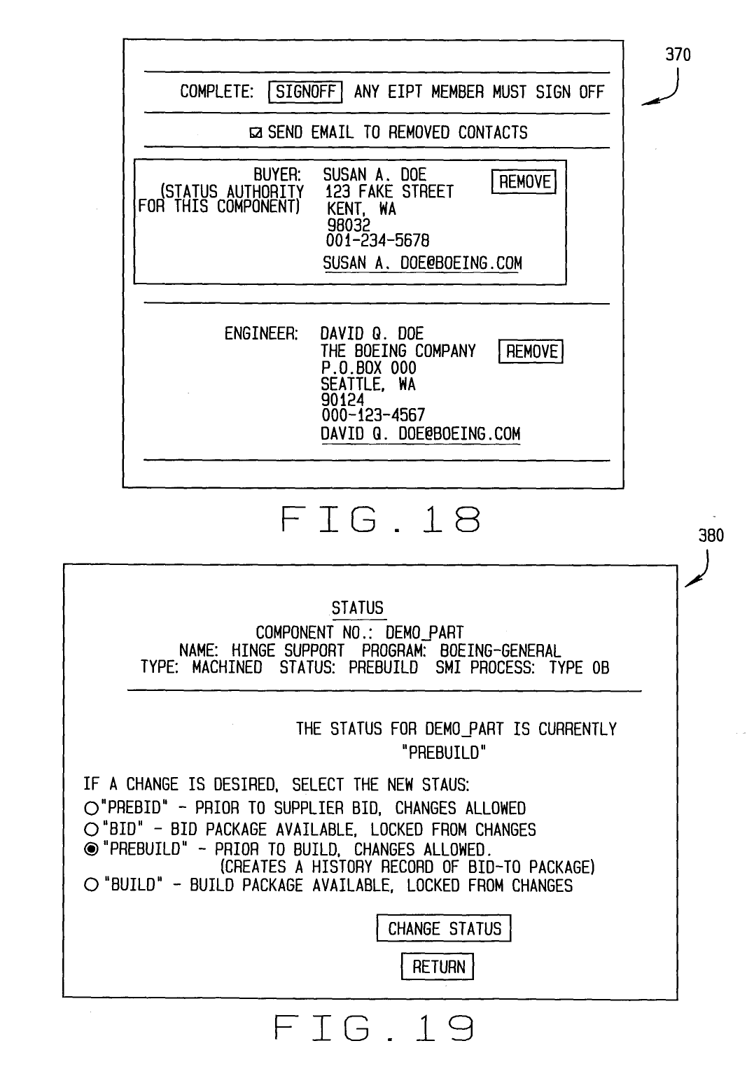

FIG. 18 is an illustration of a panel 370 through which the responsible person(s) may use to sign off on a process step.

FIG. 19 illustrates a panel 380 that allows the qualified user (e.g., buyer or hardware manager) to select or change the status of the component.

FIG. 20 illustrates a warning notice 390 that may be displayed when the component contains International Traffic In Arms (ITAR) controlled data.

FIG. 21 illustrates a panel 400 that allows a user to select a report from a variety of listed reports and then have that report generated by the network application.

During the supplier manufacturing integration process, the present invention also allows for management of the various stages comprising a component's life cycle, from creating the component until the component is archived or deleted from the SMI process. FIG. 23 illustrates an exemplary component life cycle 410 and the various stages thereof that may be managed during an integrated supplier manufacturing process enabled by the system shown in FIG. 1 according to a preferred embodiment of the present invention. In FIG. 23, arrows 412 and 414 indicate the normal life cycle flow of a component. The various component life cycle stages shown in FIG. 23 and brief descriptions thereof are as follows:

“In Work”—A component that is being worked, which is visually indicated by one or more process steps not being signed off. As described earlier, component status, user type, and user account type determine the level of component data read/write capability for a user.

“Completed”—A component that has been delivered per contract or agreement requirements, which is visually indicated by all process objects being signed off and/or the completion of the Deliver Component information. As described earlier, component status, user type, and user account type determine the level of component data read/write capability for a user.

“Archived”—Metadata is maintained in the Archive portion of the system. The stored data files may be maintained at a storage location or deleted to conserve storage space. The component is locked from changes. If the component is returned to “In Work”, the available data files are recovered.

“Suspend Work”—Indicates to all users, particularly a supplier, that all work on the component is to cease. This state will usually occur when a major design revision is pending, but can also occur for logistical or contractual reasons. Suspend Work user privilege tables are used to define component read/write capabilities.

“Cancelled/Obsolete”—A component that is no longer needed, for example a major design revision that eliminated the component or the component was cancelled in the master PDM or procurement system. In the Cancelled/Obsolete state, a part in the master PDM system or drawing has been deactivated, but the part number remains in existence. The system displays that the part is in this life cycle state and identifies basic component information such as part number, part name (nomenclature), inactivation date, and engineering or data management person(s) to contact. All component information is locked from changes and only the basic information is readable.

“Inactive”—A component that is no longer being worked. This could be manually triggered or triggered by the system after a period of inactivity. All component information is locked from changes. Inactive components are either Archived or returned to In Work life cycle state.

“Deleted”—When a component is deleted, all database records and files are removed with no historical record. An administrator has the ability to delete any component under any conditions. Currently, this is performed only for errors or when a part is replaced by another part, with close consultation with the buyer or hardware manager. Users delete components under the following rules:

1. If anything in the component has been signed off, a delete will not be allowed by any user.

2. If there are no signoffs and a status authority (buyer, hardware manager) is in the EIPT, then only that status authority can delete the component.

3. If there are no signoffs and no status authority in the EIPT, then anyone in the EIPT can perform the delete. This would likely be the case if a user has just created a part with a bogus name.

Preferably, the present invention provides event notifications of component state changes; locks up specific data to prevent changes such as details in work; displays a life cycle banner on the interactive screens accessed during the supplier manufacturing integration process when a component is in the Suspend Work state or and Cancelled/Obsolete state, and/or displays a life cycle indicator that indicates each components current life cycle state (e.g., In Work, Completed, Archived, Suspend Work, Cancelled/Obsolete, Inactive, Deleted).

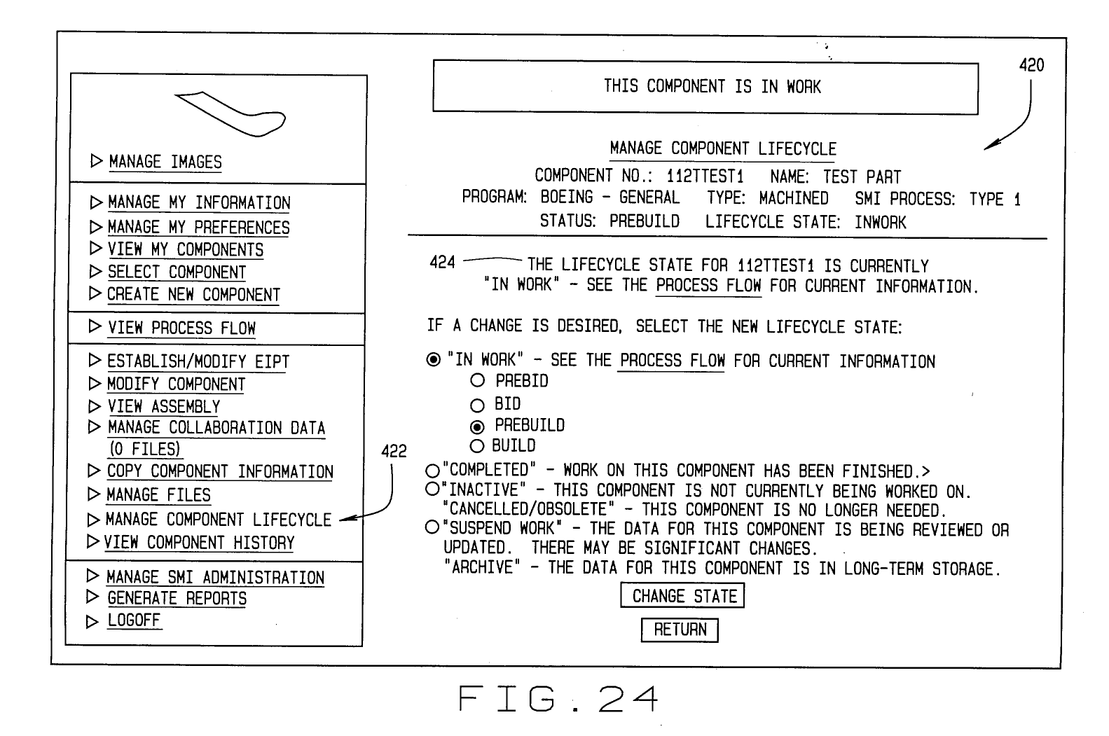

The system 10 implements the management of the various component life cycle states via a plurality of interactive screens, such as the exemplary display panels shown in FIGS. 24 through 28.

FIG. 24 illustrates a panel 420 that is displayed after the Manage Component Lifecycle Link 422 has been selected. As shown, the panel 420 includes a life cycle indicator 424 indicating the component's current life cycle state.

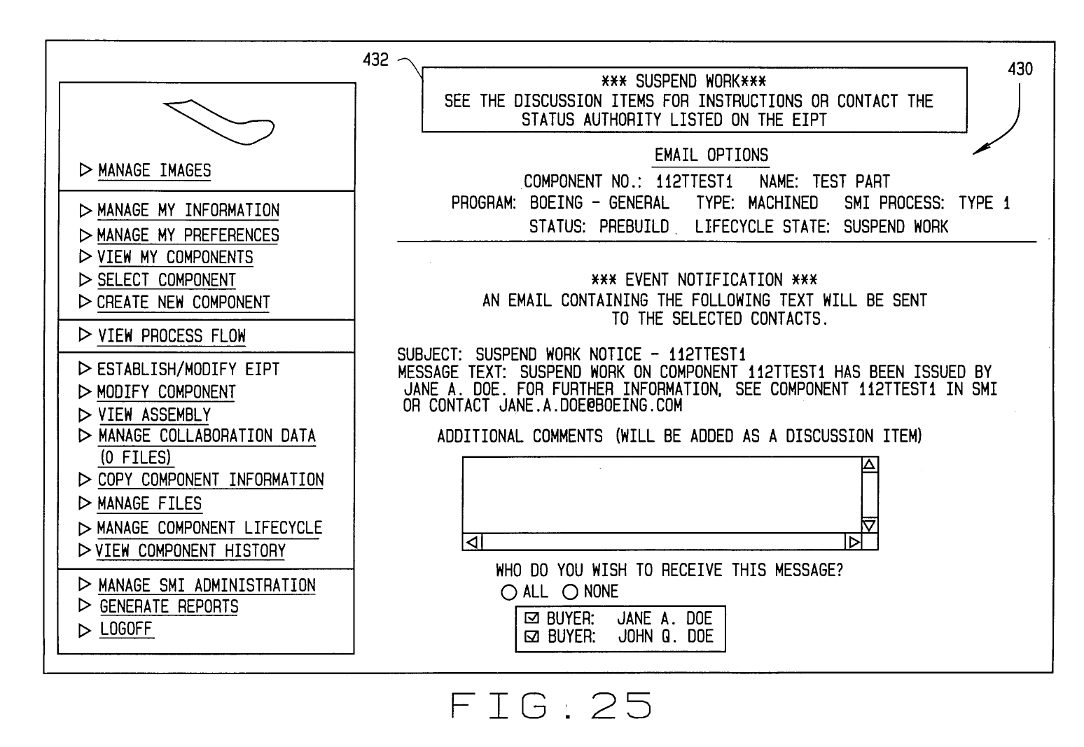

FIG. 25 illustrates an event notification window 430 that is displayed after a component state has changed to Suspend Work. As shown, the panel 430 includes a life cycle banner 432 that the component is in the Suspend Work state.

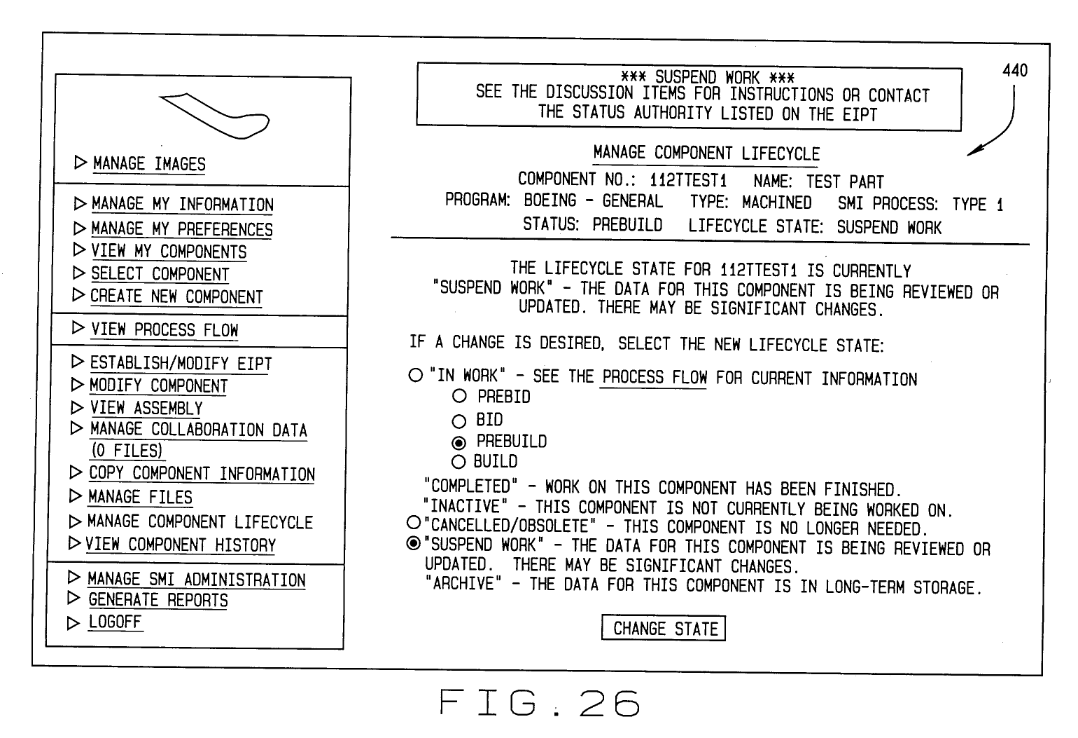

FIG. 26 illustrates a panel 440 that is displayed after the event notification window 430 in FIG. 25 has been completed.

The system 10 also preferably allows follow-on orders for additional components. During the supplier manufacturing integration process, a follow-on order is preferably assigned the same component number as the previous order for the subject component plus a Work Order designator to differentiate multiple orders for the same component number. As shown in FIG. 10, a Work Order field is accessible in the Create New Component panel 270 to allow a user to enter a work order number. Once entered, the work order number may then be displayed in the header of each of the various screen displays accessed during the supplier manufacturing integration process. In addition, the work order number may also be displayed in a screen that allows the user to select a component.

Accordingly, the present invention enables supplier manufacturing integration (SMI) by integrating the various participants into a substantially asynchronous, concurrent and collaborative design and build process. Moreover, at least one preferred embodiment of the present invention allows for at least some of the following benefits to be realized:

Standardized electronic communication that allows for more efficient management of work flow with process management and direct IPT communication between engineers, internal manufacturing, supplier management, QA, part, delivery, and suppliers;

Rapid availability of up-to-date component data (e.g., design package, build information) whenever and where needed through web-based communications and interfaces to the program information;

Automated data exchange;

Captured streams of communication by part or component for the convenience of supplier management and the IPT;

More efficient communication and coordination between suppliers and company personnel;

Standardized and trackable IPT processes for the technical side of the supply chain management;

Provides a methodology to work in the same or similar manner with internal and external suppliers;

Supplier integration level based upon component complexity;

Reduced flow-time;

Reduced costs of and improved quality of designs and supplier-fabricated components;

Reduced design issues and resulting manufacturing problems;

Ensures producibility while optimizing design to reduce complexity, variability and cost of parts;

Better management through greater understanding and tracking activity between the suppliers and the other parties involved in the process;

Standardization and configuration management of data being exchanged between the suppliers and the other parties involved in the process;

Eliminates the need for programs to develop their own unique solutions for working with suppliers;

Allows suppliers to work with various departments and programs of a company while experiencing the look and feel of one system;

Economical verification and inspection methods;

Data access of different degrees based upon user roles and component status;

Allows information to be hidden or made public at different stages of a process;

Automatic recording of export control data access logs for historical records;

Management of supplier management data through the bundling of bid-to/build-to packages;

Standard data delivery mechanisms of data;

More efficient management of change impacts due to part revisions and normal project life cycle activities;

Review of up-to-date schedules and workflow status by everyone associated with a part;

Integrated up-to-date supplier schedules with internal assembly schedules;

Data sharing across projects;

Evaluation of supplier load capacity especially when multiple projects are dealing with the same supplier;

Allows bottlenecks and process flow problems to be discovered ahead of the time;

Data encryption for secure transmission of sensitive data; and/or

Better data and data preparation for audits, First Article Inspections (FAIs) and conformity inspections.

The network application 12 is relatively easy to learn and easy to use. By using the user-friendly network application 12, the users can access data within one of the PDM systems 28 without having to learn the particularities associated with each PDM system 28.

Because the parties can relatively instantaneously access the component data via the Internet, the invention significantly reduces the amount of time that would otherwise be wasted looking for information. The invention also reduces the risk of not knowing whether the data being accessed is the latest version or not.

By allowing electronic data exchange, the present invention greatly reduces the amount of paperwork. The electronic transactions significantly reduce operating costs, especially for the paperbound and people intensive processes associated with existing design and build processes.

The difficulties suppliers have doing business with a company's numerous programs and their various processes, procedures and computing systems can be daunting. The present invention, however, standardizes and reduces the variability of the processes and tools through which the suppliers and the company communicate. Accordingly, the invention provides cost savings to suppliers, which in turn reduces the costs of components procured by the company from the supplier.

In addition, the cost a new program incurs to develop the processes and tools for working with outside suppliers can be significant. Given that a large company may include hundreds of ongoing programs, reducing the variability of such processes and tools allows for significant cost savings.

The invention is sufficiently flexible such that it can be adapted to support and thus enable the integration of a wide range of component procurement processes including relatively simple and complex programs involving extensive data. Indeed, it is anticipated that the invention will be applicable to any of a wide range of processes (e.g., interdivisional work authorization process, design offload to a supplier, etc.). Accordingly, the specific references to supplier manufacturing integration should not be construed as limiting the scope of the present invention, as the invention could be applied in any process where an understanding is needed as to who does what, when and what information is needed.

The description of the invention is merely exemplary in nature and is in no way intended to limit the invention, its application, or uses. Thus, variations that do not depart from the substance of the invention are intended to be within the scope of the invention. Such variations are not to be regarded as a departure from the spirit and scope of the invention.

What is claimed is:

1. A method for enabling supplier manufacturing integration, the method comprising:
integrating at least one supplier and a company seeking a component from said supplier into a collaborative process in which information sharing and coordination between various subgroups of the company and the supplier is desired; and
allowing collaboration between the company and the supplier during at least a portion of the collaborative process.

2. The method of claim 1, wherein allowing collaboration between the company and the supplier during at least a portion of the collaborative process comprises allowing substantially asynchronous and concurrent electronic data exchange between the company and the supplier.

3. The method of claim 1, further comprising:
selecting a business model for the collaborative process, the business model comprising at least one process step;
providing component data in accordance with the selected business model;
managing the component data in accordance with the selected business model; and
managing each process step in accordance with the selected business model.

4. The method of claim 3, further comprising providing an event notification upon completion of a process step, the event notification indicating the process step completion and indicating a next process step to be performed.

5. The method of claim 3, further comprising allowing each process step, upon completion, to be signed off by a designated person.

6. The method of claim 3, further comprising using at least one of component status, user type, and account type to determine a level of component data access and capability for a user.

7. The method of claim 3, wherein selecting a business model comprises selecting a predefined process template.

8. The method of claim 3, further comprising creating a customized process template; and wherein selecting a business model comprises selecting the customized process template.

9. The method of claim 3, further comprising providing a user with component data relative to a user-selected process step.

10. The method of claim 3, wherein the process steps of the selected business model comprise at least one of:
establishing an extended integrated product team;
developing a digital product definition;
conducting a producibility review;
developing a request for quote and configuring a bid-to package;
submitting a response for a bid-to package;
finalizing a build-to package;
selecting a supplier and releasing a purchase contract;
assigning a supplier;
developing a manufacturing plan, tools and media;
fabricating a component; or
delivering a component.

11. The method of claim 1, further comprising managing a plurality of life cycle states for the component during at least a portion of the collaborative process.

12. The method of claim 11, further comprising providing an event notification upon a change in the life cycle state of the component, the event notification indicating the current life cycle state for the component.

13. The method of claim 11, wherein the plurality of life cycle states for the component comprise at least one of:
in work;
completed;
archived;
suspend work;
cancelled;
obsolete;
inactive; or
deleted.

14. The method of claim 1, further comprising allowing follow-on orders for the component during at least a portion of the collaborative process.

15. A method for enabling supplier manufacturing integration, the method comprising:
selecting a business model for a collaborative process, the business model comprising at least one process step;
using at least one of component status, user type, and account type to determine a level of component data access and capability for a user;
allowing a user to provide component data in accordance with the selected business model and with the user's level of component data access and capability;
managing the component data in accordance with the selected business model;
managing each process step in accordance with the selected business model;
providing an event notification upon completion of a process step, the event notification indicating the process step completion and indicating a next process step to be performed; and
allowing each process step, upon completion, to be signed off by a designated person before a corresponding event notification is provided.

16. The method of claim 15, wherein selecting a business model comprises selecting a predefined process template for the business model.

17. The method of claim 15, further comprising creating a customized process template; and wherein selecting a business model comprises selecting the customized process template for the business model.

18. The method of claim 15, further comprising managing a plurality of life cycle states for the component during at least a portion of the collaborative process.

19. The method of claim 18, further comprising providing an event notification upon a change in the life cycle state of the component, the event notification indicating the current life cycle state for the component.

20. A system for enabling supplier manufacturing integration, the system comprising:
a computer executable module for integrating at least one supplier and a company seeking a component from said supplier into a collaborative process in which information sharing and coordination between various subgroups of the company and the supplier is desired; and
a computer executable module for allowing electronic data exchange between the supplier and the company during at least a portion of the collaborative process.

21. The system of claim 20, further comprising:
a computer executable module for capturing data residing on a network; and
a computer executable module for allowing at least one user to access the captured data.

22. The system of claim 21, wherein the network comprises the Internet.

23. The system of claim 21, further comprising a computer executable module for interfacing with at least one product data management system linked to the network.

24. The system of claim 20, further comprising a computer executable module for implementing an interface, the interface allowing at least one user input for the collaborative process.

25. The system of claim 24, wherein the interface comprises at least one interactive screen.

26. The system of claim 20, further comprising:
a computer executable module for allowing a user to select a business model for the collaborative process, the business model comprising at least one process step;
a computer executable module for allowing a user to provide component data in accordance with the selected business model;
a computer executable module for managing each process step in accordance with the selected business model;
a computer executable module for managing the component data in accordance with the selected business model; and
a computer executable module for providing an event notification in accordance with the selected business model, the event notification indicating a next process step to be performed and indicating the completion of a prior process step.

27. The system of claim 26, further comprising a computer executable module for allowing each process step, upon completion, to be signed off by a designated person before the corresponding event notification is provided.

28. The system of claim 26, further comprising a computer executable module for using at least one of component status, user type, and account type to determine a level of component data access and capability for a user.

29. The system of claim 26, further comprising a computer executable module for allowing a user to create a customized process template, the customized process template being available for selection as a business model.

30. The system of claim 26, further comprising a computer executable module for providing a user with component data relative to a corresponding process step.

31. The system of claim 20, further comprising a computer executable module for managing a plurality of life cycle states for the component during at least a portion of the collaborative process.

32. The system of claim 31, further comprising a computer executable module for providing an event notification upon a change in the life cycle state of the component, the event notification indicating the current life cycle state for the component.
